(19) United States
(12) Patent Application Publication
(10) Pub. No.: US 2026/0148472 A1
(43) Pub. Date: May 28, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: ATSUSHI ISHIHARA, TOKYO (JP)

(21) Appl. No.: 19/121,598

(22) PCT Filed: Aug. 30, 2023
(86) PCT No.: PCT/JP2023/031553

§ 371 Date: Apr. 16, 2025

(30) Foreign Application Priority Data
Oct. 24, 2022 (JP) 2022-169768

(51) Int. Cl. G06T 15/04; G06F 3/01; G06T 15/50

(52) U.S. Cl. CPC G06T 15/04; G06F 3/013; G06T 15/50; G06T 2210/21

(57) ABSTRACT

Light of a real space is reflected on a surface of a three-dimensional virtual object to be superimposed on the real space in real time.

An information processing device includes a mapping unit that maps an environment image obtained by capturing an image of a surrounding environment in real time on each surface of a predetermined three-dimensional body, and a reflection drawing unit that derives a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.

### TECHNICAL FIELD

The present disclosure relates to an information processing device, an information processing method, and a program.

### BACKGROUND ART

In recent years, extended reality (XR) technology has become common in which a three-dimensional virtual object is superimposed on a real space to make the virtual object appear as if it exists in the real space.

On the other hand, in the real space, a user can recognize the shape and characteristics of the object surface by visually recognizing the light reflected by the surface of the object. For example, the user can understand the unevenness, texture, material, or the like of the object surface by visually recognizing that surrounding light is reflected like a mirror when reaching the object or that a part of light is sharply or obtusely reflected.

Therefore, in order to cause the user to visually recognize the texture, shape, or positional relationship of the virtual object with high accuracy, it has been studied to similarly reflect the light of the real space on the surface of the virtual object in real time for the virtual object to be superimposed on the real space.

For example, Patent Document 1 below discloses a technique of incorporating real-time reflection of a user and a surrounding environment into a graphical user interface.

### CITATION LIST

### Patent Document

Patent Document 1: Japanese Patent Application Laid-Open No. 2009-252240

### SUMMARY OF THE INVENTION

### Problems to be Solved by the Invention

However, since the technique disclosed in Patent Document 1 is a technique of imparting a reflection effect to a two-dimensional user interface displayed on a two-dimensional display, it is difficult to impart reflection of light to the surface of a three-dimensional virtual object.

Therefore, the present disclosure proposes a new and improved information processing device, information processing method, and program capable of reflecting light in a real space in real time on a surface of a three-dimensional virtual object to be superimposed on the real space.

### Solutions to Problems

According to the present disclosure, there is provided an information processing device including: a mapping unit that maps an environment image obtained by capturing an image of a surrounding environment in real time on each surface of a predetermined three-dimensional body; and a reflection drawing unit that derives a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.

Furthermore, according to the present disclosure, there is provided an information processing method by an arithmetic processing device, including: mapping an environment image obtained by capturing an image of a surrounding environment in real time on each surface of a predetermined three-dimensional body; and deriving a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generating a reflected image to be superimposed on the surface of the virtual object by using the derived environment image of the partial region.

Moreover, according to the present disclosure, there is provided a program causing a computer to function as: a mapping unit that maps an environment image obtained by capturing an image of a surrounding environment in real time on each surface of a predetermined three-dimensional body; and a reflection drawing unit that derives a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.

### BRIEF DESCRIPTION OF DRAWINGS

FIG. 1 is a block diagram illustrating a functional configuration of an information processing device for mapping an environment image on a predetermined three-dimensional body and evaluating surface characteristics of a virtual object.

FIG. 2 is an explanatory diagram for explaining mapping of an environment image onto a predetermined three-dimensional body.

FIG. 3 is a flowchart illustrating a flow of processing of evaluating surface characteristics of a virtual object.

FIG. 4 is an explanatory diagram for explaining processing in evaluating a surface of a virtual object.

FIG. 5 is a schematic diagram illustrating an outline of an information processing device according to a first embodiment of the present disclosure.

FIG. 6 is a block diagram illustrating a functional configuration of the information processing device according to the first embodiment.

FIG. 7 is a flowchart illustrating a flow of processing of the information processing device according to the first embodiment.

FIG. 8 is a schematic diagram illustrating an outline of processing in the information processing device according to the first embodiment.

FIG. 9 is a schematic diagram illustrating an outline of an information processing device according to a second embodiment of the present disclosure.

FIG. 10 is a schematic diagram illustrating an outline of an information processing device according to a third embodiment of the present disclosure.

FIG. 11 is a block diagram illustrating a functional configuration of the information processing device according to the third embodiment.

FIG. 12 is a schematic diagram illustrating an outline of an information processing device according to a fourth embodiment of the present disclosure.

FIG. 13 is a block diagram illustrating a functional configuration of the information processing device according to the fourth embodiment.

FIG. 14 is a schematic perspective view illustrating a configuration of a mirror-finished body.

FIG. 15 is a flowchart illustrating a flow of processing of the information processing device according to the fourth embodiment.

FIG. 16 is a schematic diagram illustrating an outline of an information processing device according to a fifth embodiment of the present disclosure.

FIG. 17 is a block diagram illustrating a functional configuration of the information processing device according to the fifth embodiment.

FIG. 18 is a flowchart illustrating a flow of operation of the information processing device and a sensor device according to the fifth embodiment.

FIG. 19 is a block diagram illustrating functional configurations of an information processing device and a sensor device according to a first modification.

FIG. 20 is a flowchart illustrating a flow of operation of the information processing device and the sensor device according to the first modification.

FIG. 21 is a block diagram illustrating functional configurations of an information processing device and a sensor device according to a second modification.

FIG. 22 is a flowchart illustrating a flow of operation of the information processing device and the sensor device according to the second modification.

FIG. 23 is a block diagram illustrating functional configurations of an information processing device and a sensor device according to a third modification.

FIG. 24 is a flowchart illustrating a flow of operation of the sensor device according to the third modification.

FIG. 25 is a flowchart illustrating a flow of operation of the information processing device according to the third modification.

FIG. 26 is a block diagram illustrating functional configurations of an information processing device and a sensor device according to a fourth modification.

FIG. 27 is a flowchart illustrating a flow of operation of the information processing device according to the fourth modification.

FIG. 28 is a timing chart of an information processing device and a sensor device according to a fifth embodiment.

FIG. 29 is a timing chart of the information processing device and the sensor device according to the fourth modification.

FIG. 30 is a flowchart illustrating an operation example of controlling resolution of a sensor unit that captures an environment image according to a distance between a user and a virtual object.

FIG. 31 is a flowchart illustrating an operation example of controlling resolution of an environment image on the basis of priority of an object included in a region of the environment image captured by a sensor.

FIG. 32 is a block diagram illustrating exemplary hardware configuration of an information processing device according to each embodiment.

### MODE FOR CARRYING OUT THE INVENTION

Hereinafter, preferred embodiments of the present disclosure will be described in detail with reference to the accompanying drawings. Note that, in the present specification and drawings, components having substantially the same functional configuration are denoted by the same reference numerals to avoid the description from being redundant.

Note that explanation will be made in the following order.
1. Common Configuration
2. First Embodiment
   2.1. Configuration
   2.2. Operation
3. Second Embodiment
4. Third Embodiment
5. Fourth Embodiment
   5.1. Configuration
   5.2. Operation
6. Fifth Embodiment
   6.1. Configuration
   6.2. Operation
   6.3. Modifications
7. Variations
   7.1. First Variation
   7.2. Second Variation
8. Hardware Configuration

### 1. Common Configuration

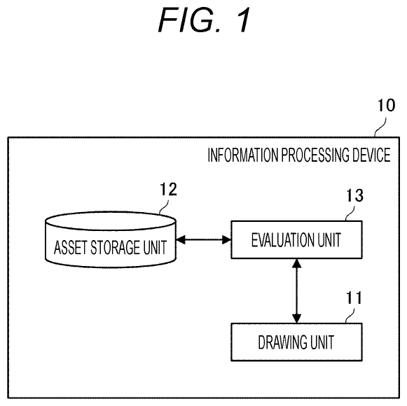

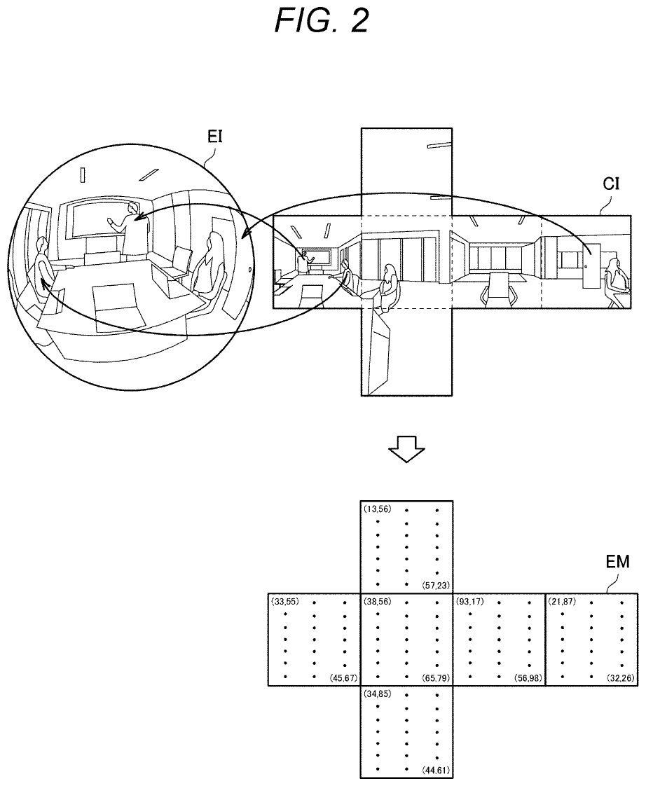

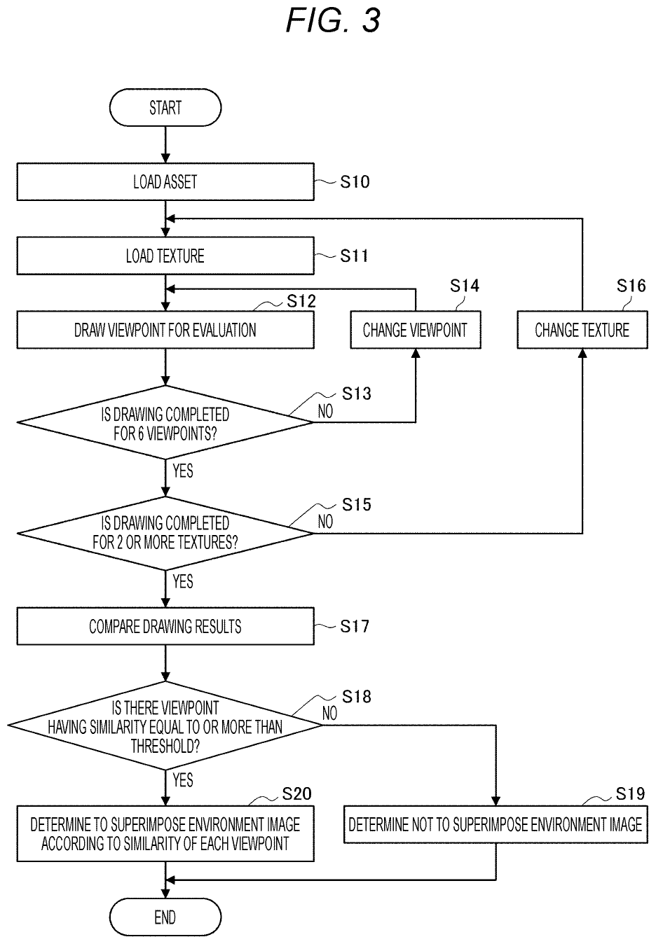

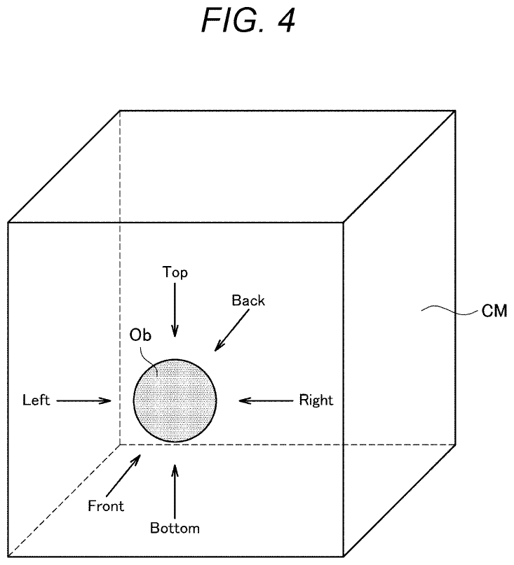

First, a configuration common to the embodiments of the present disclosure will be described with reference to FIGS. 1 to 4. FIG. 1 is a block diagram illustrating a functional configuration of an information processing device 10 for mapping an environment image on a predetermined three-dimensional body and evaluating surface characteristics of a virtual object. FIG. 2 is an explanatory diagram for explaining mapping of an environment image onto a predetermined three-dimensional body. FIG. 3 is a flowchart illustrating a flow of processing of evaluating surface characteristics of a virtual object. FIG. 4 is an explanatory diagram for explaining processing in evaluating a surface of a virtual object.

As illustrated in FIG. 1, the information processing device 10 includes a drawing unit 11, an asset storage unit 12, and an evaluation unit 13. The information processing device 10 generates a cube map used when an environment image is reflected on the surface of a virtual object as a previous stage of drawing the virtual object. Moreover, the information processing device 10 evaluates the reflection characteristics of the surface of the virtual object using the generated cube map.

The drawing unit 11 maps the environment image on each surface of a three-dimensional body having a predetermined shape. The environment image may be, for example, an image obtained by imaging a real space in which a virtual object is drawn in real time, or may be an evaluation texture for evaluating the reflection characteristics of the virtual object by the evaluation unit 13 described later.

The three-dimensional body having the predetermined shape is a map of a cubic shape used for deriving an environment image reflected on the surface of the virtual object. Such a map is also referred to as a cube map. The drawing unit 11 can generate a virtual space for reflecting the environment image on the surface of the virtual object by drawing the virtual object inside the cube map in which the environment image is mapped on each surface.

For example, as illustrated in FIG. 3, the drawing unit 11 first generates a mapping image CI by developing an environment image EI obtained by imaging the real space with a wide-angle camera such as a fisheye camera on each surface of the cube map of the cubic shape. Next, the drawing unit 11 generates a cube conversion map EM in which the position of each pixel of the mapping image CI and the position of each face of the cube map are associated by mapping. According to this, the drawing unit 11 can uniquely determine the correspondence relationship between the coordinates (x, y) on the hemispherical coordinate system of the environment image EI and the coordinates (X, Y) on the cube map coordinate system. Since this correspondence relationship is static, it can be similarly used even in a case where the position and posture of the imaging device that images the real space change.

The asset storage unit 12 stores asset information of a virtual object to be superimposed on the real space. The asset information of the virtual object is a collection of information necessary for drawing the virtual object, and includes, for example, the shape, texture, animation, or the like of the virtual object. The asset information of the virtual object may be defined in a known format such as an Obj format or an FBX format.

The asset information of the virtual object includes information associated with information regarding a normal vector of the surface of the virtual object. The normal vector is a vector indicating a direction in which a vertex, a pixel, or a surface including a plurality of vertices of a surface of a virtual object is oriented (that is, a vector indicating a direction perpendicular to the plane). The normal vector of the surface of the virtual object is referenced to derive a reflection vector of light at the surface of the virtual object.

The evaluation unit 13 generates evaluation information of the virtual object obtained by evaluating reflection on each surface of the virtual object. Specifically, the evaluation unit 13 instructs the drawing unit 11 to draw to perform drawing for evaluating reflection on each surface of the virtual object, and generates evaluation information of the virtual object on the basis of the surface state of the virtual object drawn by the drawing unit 11. The virtual object may include a portion having a low reflectance of the surface. Therefore, by evaluating the reflection on the surface of the virtual object, the evaluation unit 13 can evaluate whether or not to reflect the light in the real space on the surface of the virtual object, and with what resolution or color number in the case of reflecting the light in the real space.

For example, the evaluation unit 13 causes the drawing unit 11 to draw a virtual object inside the cube map in which the evaluation texture is mapped on each surface, and compares each surface of the drawn virtual object with the evaluation texture. According to this, the evaluation unit 13 can evaluate the reflection characteristics of each surface of the virtual object by evaluating how much the evaluation texture mapped on the cube map is reflected on each surface of the virtual object.

The information processing device 10 may evaluate the reflection characteristics of each surface of the virtual object according to the flow of the operation illustrated in FIG. 3.

As illustrated in FIG. 3, the evaluation unit 13 reads asset information of a virtual object to be evaluated from the asset storage unit 12 (S10). Next, the evaluation unit 13 reads the evaluation texture mapped to each face of the cube map (S11).

Thereafter, on the basis of the instruction from the evaluation unit 13, the drawing unit 11 draws the virtual object at the viewpoint for evaluation using the read asset information and evaluation texture (S12).

At this time, the drawing unit 11 may draw the virtual object from six directions of top, bottom, front, back, left, and right in order to cause the evaluation unit 13 to evaluate the reflectance and the reflection color characteristics in all directions of the virtual object. For example, as illustrated in FIG. 4, the drawing unit 11 may draw a virtual object Ob arranged inside a cube map CM in which the evaluation texture is mapped on each surface from viewpoints of six directions of top, bottom, front, back, left, and right.

Thereafter, it is determined whether or not the drawing has been completed at all the viewpoints in the six directions (S13). In a case where the drawing is not completed (S13/No), the drawing unit 11 changes the viewpoint (S14), and executes the drawing of the virtual object in step S12 again.

In a case where the drawing has been completed (S13/Yes), the drawing unit 11 further determines whether or not the virtual object has been drawn after mapping two or more evaluation textures on the cube map (S15). In a case where the drawing is not completed (S15/No), the drawing unit 11 changes the evaluation texture (S16), and executes the drawing of the virtual object in step S12 again. This is because, in order to more accurately evaluate the reflectance and the reflection color characteristics of the surface of the virtual object, it is important to draw the virtual object using at least two or more kinds of evaluation textures having different patterns or colors.

In a case where the drawing is completed (S15/Yes), the evaluation unit 13 compares the evaluation texture with the drawing result of the surface of the virtual object for each evaluation texture and for each viewpoint (S17). Comparison between the evaluation texture and the drawing result is performed using a metric such as a peak signal to noise ratio (PSNR) or a structural similarity (SSIM). These indexes are indexes indicating that the higher the numerical value, the higher the similarity between the images. By using these indexes, the evaluation unit 13 can evaluate the similarity between the evaluation texture and the drawing result of the surface of the virtual object in which the evaluation texture is reflected.

Subsequently, the evaluation unit 13 determines whether or not there is a viewpoint at which the similarity (PSNR or SSIM) between the evaluation texture and the drawing result is equal to or greater than a threshold (S18). Note that the similarity between the evaluation texture and the drawing result in different evaluation textures is obtained by comparing the same viewpoints and adopting a higher similarity.

The threshold for determination in step S18 is, for example, a threshold for determining whether or not the evaluation texture is reflected on the surface of the virtual object. In a case where the similarity between the evaluation texture and the drawing result is high, the evaluation unit 13 can determine that the reflection characteristic of the surface of the virtual object is high and the evaluation texture is reflected on the surface of the virtual object by reflection. On the other hand, in a case where the similarity between the evaluation texture and the drawing result is low, the evaluation unit 13 can determine that the reflection characteristic of the surface of the virtual object is low and the evaluation texture is not reflected.

In a case where there is no viewpoint having a similarity equal to or higher than the threshold (S18/No), the evaluation unit 13 determines that the reflection characteristic of the surface of the virtual object is low, and determines not to superimpose the environment image on the surface of the virtual object at the time of drawing the virtual object in the subsequent stage (S19). Thereafter, the evaluation unit 13 generates the determination as evaluation information and stores the evaluation information in the asset storage unit 12 in association with the asset information of the virtual object.

On the other hand, in a case where there is a viewpoint having a similarity equal to or higher than the threshold (S18/Yes), the evaluation unit 13 determines that the reflection characteristic of the surface of the virtual object having the similarity equal to or higher than the threshold is high, and determines to superimpose the environment image on the surface of the virtual object when the virtual object is drawn in the subsequent stage (S20). Thereafter, the evaluation unit 13 generates the determination as evaluation information and stores the evaluation information in the asset storage unit 12 in association with the asset information of the virtual object.

Moreover, the evaluation unit 13 may generate evaluation information instructing higher definition of the environment image superimposed on the surface of the virtual object at each viewpoint according to the degree of similarity. The high similarity between the evaluation texture and the drawing result of the surface of the virtual object indicates that the evaluation texture is reflected more clearly on the surface of the virtual object. Therefore, the evaluation unit 13 may generate evaluation information that instructs to further increase the number of colors while further increasing the resolution of the environment image superimposed on the surface of the virtual object as the similarity is higher.

According to the processing of evaluating the reflection characteristic of the surface of the virtual object described above, the information processing device 10 generates the evaluation information obtained by evaluating the reflection characteristics on the surface of the virtual object to be drawn, thereby lessening or reducing the processing on the portion having the low reflectance. Therefore, the information processing device 10 can further reduce the processing load in drawing the virtual object.

Note that the evaluation information indicating the reflection characteristics of the surface of the virtual object may be set, for example, in advance by a creator of the asset information of the virtual object instead of being evaluated by the evaluation unit 13.

### 2. First Embodiment

### (2.1. Configuration)

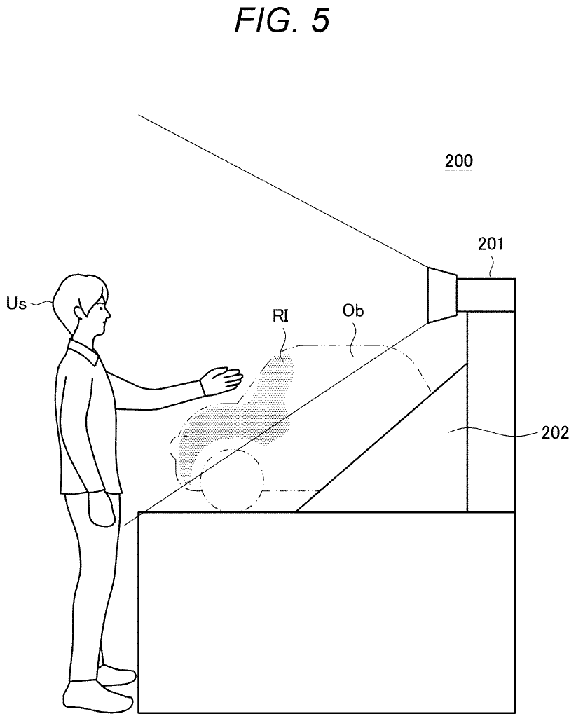

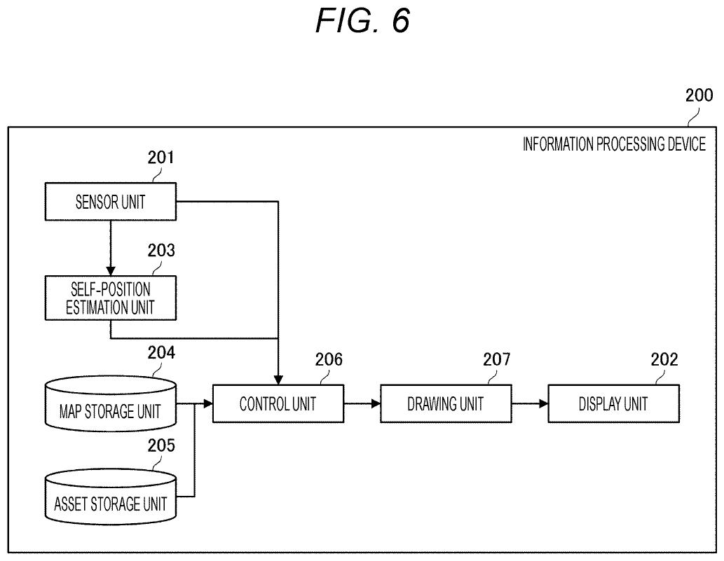

Next, a configuration of an information processing device according to a first embodiment of the present disclosure will be described with reference to FIGS. 5 and 6. FIG. 5 is a schematic diagram illustrating an outline of an information processing device 200 according to the present embodiment.

As illustrated in FIG. 5, the information processing device 200 according to the present embodiment is a so-called stationary XR display. A user Us can visually recognize the virtual object Ob superimposed on the real space in front of a display unit 202 by the display unit 202 that is a light-field display. At this time, an environment image RI captured by a sensor unit 201 installed in front of the user Us is superimposed on the surface of the virtual object Ob.

The virtual object Ob illustrated in FIG. 5 is drawn by the information processing device 200 illustrated in FIG. 6. FIG. 6 is a block diagram illustrating the functional configuration of the information processing device 200 according to the present embodiment.

As illustrated in FIG. 6, the information processing device 200 includes a sensor unit 201, a self-position estimation unit 203, a map storage unit 204, an asset storage unit 205, a control unit 206, a drawing unit 207, and a display unit 202.

The sensor unit 201 includes an imaging device that images the environment on the user Us side. For example, the sensor unit 201 may include an imaging device including a fisheye lens having a wide viewing angle. The image captured by the sensor unit 201 is used as an environment image mapped on each surface of the cube map, and is used by the self-position estimation unit 203 to estimate the position of the head and the direction of the line-of-sight of the user Us.

The self-position estimation unit 203 estimates the position of the user Us on the basis of the input from the sensor unit 201. In the present embodiment, since the sensor unit 201 and the presentation location of the virtual object Ob are fixed, the self-position estimation unit 203 can estimate the position of the head and the direction of the line-of-sight of the user Us on the basis of the image on the user Us side captured by the sensor unit 201.

The map storage unit 204 stores a cube conversion map that uniquely determines the correspondence relationship between the coordinates on the hemispherical coordinate system of the environment image and the coordinates on the cube map coordinate system. The cube conversion map is data indicating a correspondence relationship between the position of each pixel of the environment image to be mapped and the position of each face of the cube map.

Similarly to the asset storage unit 12 described above, the asset storage unit 205 stores the asset information of the virtual object Ob to be superimposed on the real space.

The control unit 206 instructs the drawing unit 207 to draw the virtual object Ob. For example, the control unit 206 may instruct the drawing unit 207 to draw using a drawing library such as OpenGL (registered trademark), Vulkan (registered trademark), or DirectX (registered trademark).

Specifically, the control unit 206 first instructs the drawing unit 207 to map the image on the user Us side captured by the sensor unit 201 to the cube map and draw the virtual object Ob inside the cube map. Next, the control unit 206 derives a reflection vector on the surface of the virtual object Ob on the basis of the estimated line-of-sight direction of the user Us and the normal vector of the surface of the virtual object Ob. Moreover, the control unit 206 instructs the drawing unit 207 to superimpose the environment image of the intersection of the derived reflection vector and the cube map on the surface of the virtual object Ob. Note that, when the environment image is to be superimposed on the surface of the virtual object Ob, the control unit 206 may instruct the drawing unit 207 to perform drawing with reference to the evaluation information of the virtual object Ob stored in the asset storage unit 205.

The reflection vector may be, for example, a vector indicating reflection when the line-of-sight vector indicating the line-of-sight direction of the user Us is totally reflected on the surface of the virtual object Ob. More specifically, the reflection vector may be a vector that is emitted from the intersection of the line-of-sight vector indicating the line-of-sight direction of the user Us and the normal vector of the surface of the virtual object Ob to the opposite side of the line-of-sight vector at the same angle as an angle formed by the line-of-sight vector and the normal vector. Since the environment image mapped on the cube map ahead of the line-of-sight direction of the user Us reflected on the surface of the virtual object Ob is superimposed on the surface of the virtual object Ob, the user Us can visually recognize the virtual object Ob with a more realistic feeling. Note that, depending on the characteristics of the surface of the virtual object Ob, the reflection vector may be a vector indicating reflection when the line-of-sight vector indicating the line-of-sight direction of the user Us is reflected on the surface of the virtual object Ob in a manner different from total reflection.

The drawing unit 207 draws the virtual object Ob in accordance with an instruction from the control unit 206.

The display unit 202 displays a drawing result by the drawing unit 207. The display unit 202 may be a light field display including a liquid crystal display (LCD) device or an organic electro-luminescence (EL) device.

According to the above configuration, the information processing device 200 according to the present embodiment allows the user Us to visually recognize the virtual object Ob in which the environment image captured in real time is superimposed on the surface.

### (2.2. Operation)

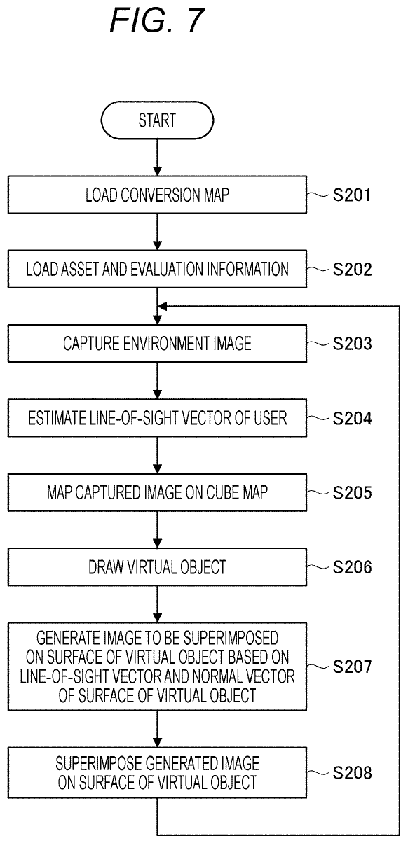

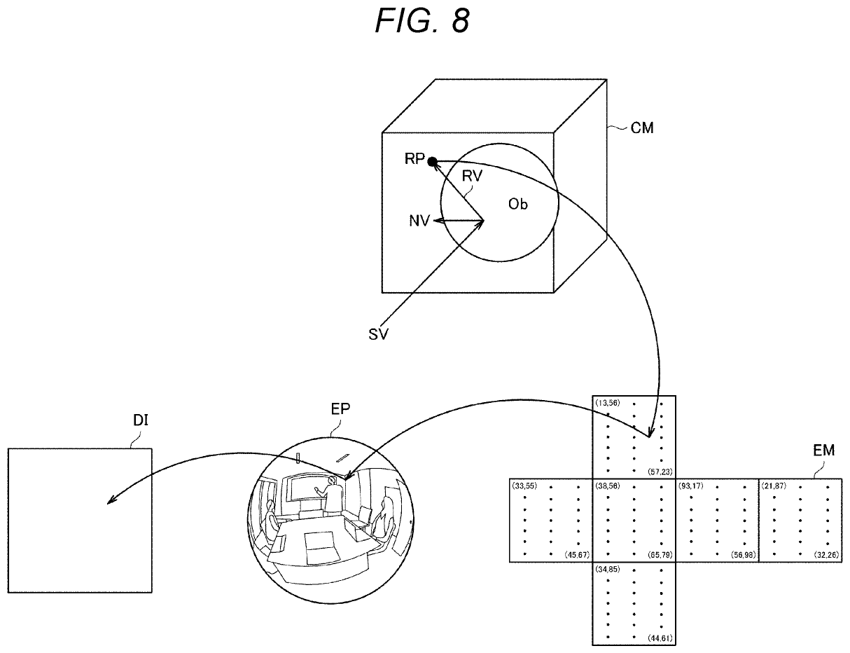

Subsequently, an operation example of the information processing device 200 according to the present embodiment will be described with reference to FIGS. 7 and 8. FIG. 7 is a flowchart illustrating a flow of operation of the information processing device 200 according to the present embodiment. FIG. 8 is a schematic diagram illustrating an outline of processing in the information processing device 200 according to the present embodiment.

As illustrated in FIG. 7, first, the control unit 206 reads the cube conversion map from the map storage unit 204 (S201). Next, the control unit 206 reads the asset information and the evaluation information of the virtual object Ob from the asset storage unit 205 (S202).

Subsequently, the sensor unit 201 captures an environment image of the user Us side (S203). Therefore, the self-position estimation unit 203 estimates the line-of-sight vector of the user Us on the basis of the captured environment image of the user Us side (S204). The line-of-sight vector of the user Us can be estimated using a known line-of-sight detection method. For example, the line-of-sight vector of the user Us may be estimated as a combined vector of both vectors having a midpoint of a line segment connecting a start point of the right-eye vector and a start point of the left-eye vector as a viewpoint.

Furthermore, the drawing unit 207 maps the captured environment image of the user Us side on the cube map (S205).

Thereafter, the drawing unit 207 draws the virtual object Ob at an arbitrary position in the world coordinates (S206), generates an image to be superimposed on the surface of the virtual object Ob (S207), and superimposes the generated image on the surface of the virtual object Ob (S208). Since the information processing device 200 according to the present embodiment is a so-called stationary XR display, the world coordinates can be considered to be the same as the sensor coordinates having the three-dimensional position of the imaging device of the sensor unit 201 as the origin.

Specifically, as illustrated in FIG. 8, the drawing unit 207 arranges the center of the cube map CM on which the environment image captured by the sensor unit 201 is mapped at the origin of the sensor coordinates, and draws the virtual object Ob at an arbitrary position inside the cube map CM (S206).

Next, the drawing unit 207 derives a reflection vector RV on the basis of a normal vector NV of the surface of the virtual object Ob and a line-of-sight vector SV of the user Us. The reflection vector RV may be derived as a vector emitted to the opposite side of the line-of-sight vector SV at the same angle as the angle formed by the line-of-sight vector SV and the normal vector NV from the intersection of the line-of-sight vector SV of the user Us and the normal vector NV of the surface of the virtual object Ob.

Here, an image of an intersection between the derived reflection vector RV and each surface of the cube map CM is an image to be superimposed on the surface of the virtual object Ob. Therefore, the drawing unit 207 can generate an image to be superimposed on the surface of the virtual object Ob by extracting an image corresponding to an intersection between the reflection vector RV and each surface of the cube map CM from an environment image EP with reference to the cube conversion map EM (S207). Moreover, the drawing unit 207 can generate an image DI to be displayed on the display unit 202 by superimposing the extracted image on the surface of the virtual object Ob (S208).

By repeating the operations in steps S203 to S208 described above for each frame, the information processing device 200 can reflect the environment image captured in real time by the sensor unit 201 on the surface of the virtual object Ob.

### 3. Second Embodiment

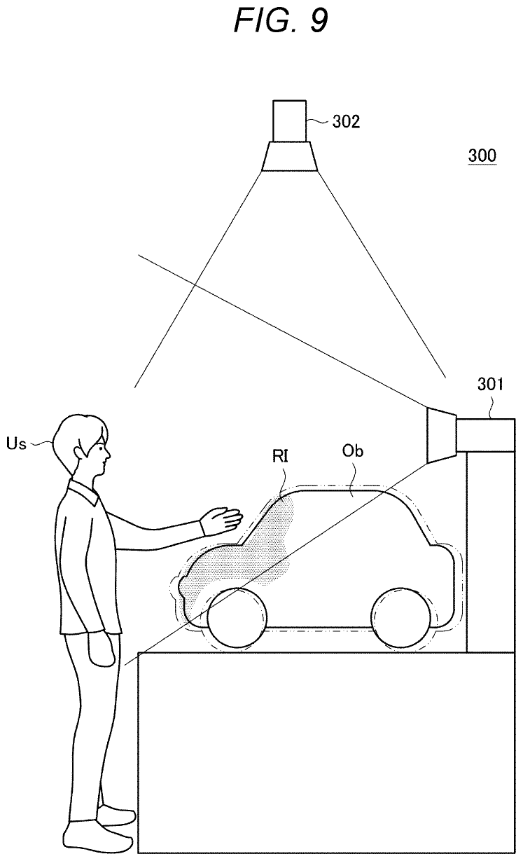

Next, a configuration of an information processing device according to a second embodiment of the present disclosure will be described with reference to FIG. 9. FIG. 9 is a schematic diagram illustrating an outline of an information processing device 300 according to the present embodiment.

As illustrated in FIG. 9, the information processing device 300 according to the present embodiment is a so-called stationary XR display using a projection mapping technology. The user Us can visually recognize the virtual object Ob superimposed on the surface of the real object by a display unit 302 which is a projector. At this time, the environment image RI captured by a sensor unit 301 installed in front of the user Us is superimposed on the surface of the virtual object Ob.

In the information processing device 300 according to the present embodiment, since the sensor unit 301 and the presentation location of the virtual object Ob are fixed, the environment image RI can be superimposed on the surface of the virtual object Ob with a configuration similar to that of the information processing device 200 according to the first embodiment. Therefore, description of the functional configuration and operation of the information processing device 300 is omitted.

### 4. Third Embodiment

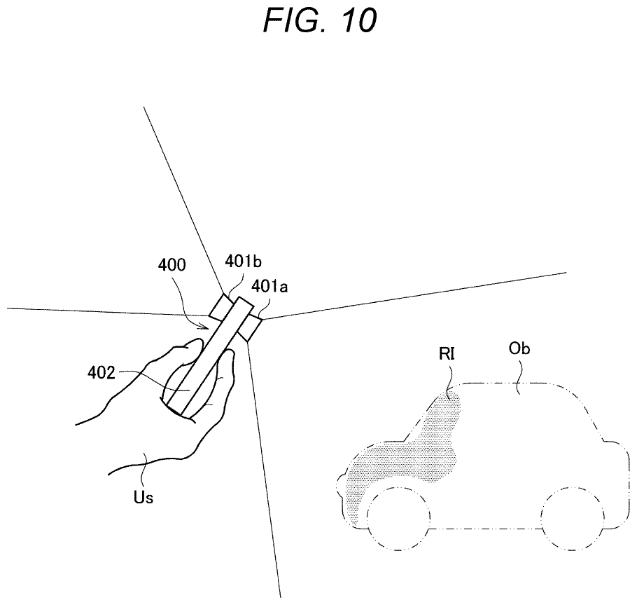

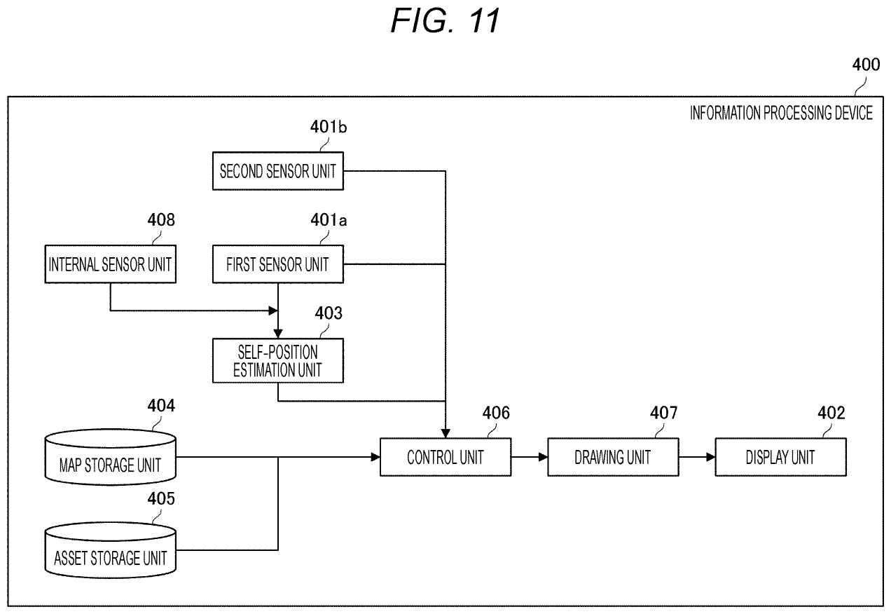

Next, a configuration of an information processing device according to a third embodiment of the present disclosure will be described with reference to FIGS. 10 and 11. FIG. 10 is a schematic diagram illustrating an outline of an information processing device 400 according to the present embodiment.

As illustrated in FIG. 10, the information processing device 400 according to the present embodiment can be applied to augmented reality (AR) technology using a mobile terminal such as a smartphone. The user Us can visually recognize the virtual object Ob superimposed on the image captured by a first sensor unit 401a via a display unit 402. At this time, the environment image RI captured by a second sensor unit 401b that captures an image of the user Us side is superimposed on the surface of the virtual object Ob.

The virtual object Ob illustrated in FIG. 10 is drawn by the information processing device 400 illustrated in FIG. 11. FIG. 11 is a block diagram illustrating the functional configuration of the information processing device 400 according to the present embodiment.

As illustrated in FIG. 11, the information processing device 400 includes a first sensor unit 401a, a second sensor unit 401b, an internal sensor unit 408, a self-position estimation unit 403, a map storage unit 404, an asset storage unit 405, a control unit 406, a drawing unit 407, and a display unit 402.

The first sensor unit 401a includes an imaging device that images the line-of-sight direction of the user Us when the display unit 402 is directed toward the user Us. The image captured by the first sensor unit 401a is displayed on the display unit 402 as a video see-through image. Furthermore, the image captured by the first sensor unit 401a is also used by the self-position estimation unit 403 to estimate the self-location of the information processing device 400.

The second sensor unit 401b includes an imaging device that images the environment on the user Us side. The image captured by the second sensor unit 401b is used as an environment image mapped to each surface of the cube map.

The internal sensor unit 408 includes an inertial sensor such as an inertial measurement unit (IMU) that measures acceleration, rotational angular acceleration, and the like acting on the information processing device 400. The information measured by the internal sensor unit 408 is used by the self-position estimation unit 403 to estimate the self-position of the information processing device 400. The internal sensor unit 408 may further include a distance measuring sensor such as a time of flight (ToF) sensor.

The self-position estimation unit 403 estimates the position and posture of the information processing device 400 on the basis of inputs from the first sensor unit 401a and the internal sensor unit 408. Specifically, the self-position estimation unit 403 can estimate the position and posture of the information processing device 400 in the world coordinates by using a technology such as simultaneous localization and mapping (SLAM), visual odometry (VO), or visual inertial odometry (VIO). In the present embodiment, since the imaging direction of the first sensor unit 401a is the line-of-sight direction of the user Us, the self-position estimation unit 403 can estimate the line-of-sight direction of the user Us by estimating the position and posture of the information processing device 400.

The map storage unit 404, the asset storage unit 405, the control unit 406, the drawing unit 407, and the display unit 402 are substantially similar to the map storage unit 204, the asset storage unit 205, the control unit 206, the drawing unit 207, and the display unit 202 described in the first embodiment, and thus description thereof is omitted here.

According to the above configuration, the information processing device 400 according to the present embodiment allows the user Us to visually recognize the virtual object Ob in which the environment image captured in real time is superimposed on the surface.

### 5. Fourth Embodiment

### (5.1. Configuration)

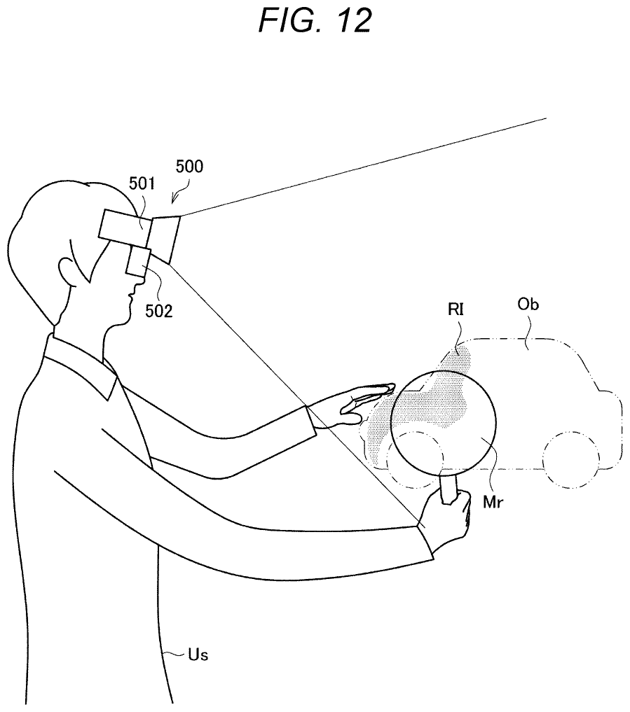

Next, a configuration of an information processing device according to a fourth embodiment of the present disclosure will be described with reference to FIGS. 12 to 14. FIG. 12 is a schematic diagram illustrating an outline of an information processing device 500 according to the present embodiment.

As illustrated in FIG. 12, the information processing device 500 according to the present embodiment can be applied to an XR technology using a head mounted display (HMD). The user Us can visually recognize the virtual object Ob superimposed on the image captured by a sensor unit 501 via a display unit 502 of the HMD. At this time, the environment image RI obtained by capturing the image reflected in a mirror-finished body Mr by the sensor unit 501 is superimposed on the surface of the virtual object Ob.

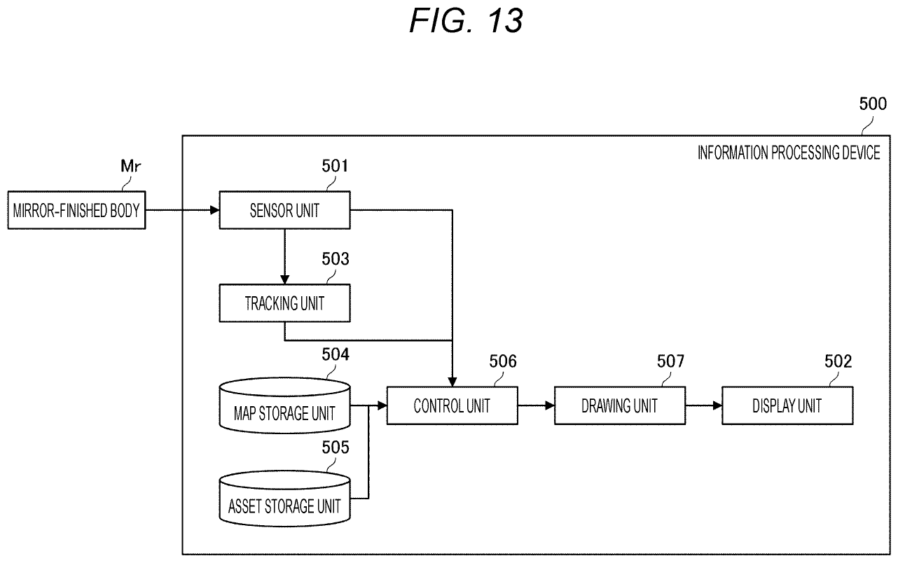

The virtual object Ob illustrated in FIG. 12 is drawn by the information processing device 500 illustrated in FIG. 13. FIG. 13 is a block diagram illustrating the functional configuration of an information processing device 500 according to the present embodiment.

As illustrated in FIG. 13, the information processing device 500 includes a sensor unit 501, a tracking unit 503, a map storage unit 504, an asset storage unit 505, a control unit 506, a drawing unit 507, and a display unit 502.

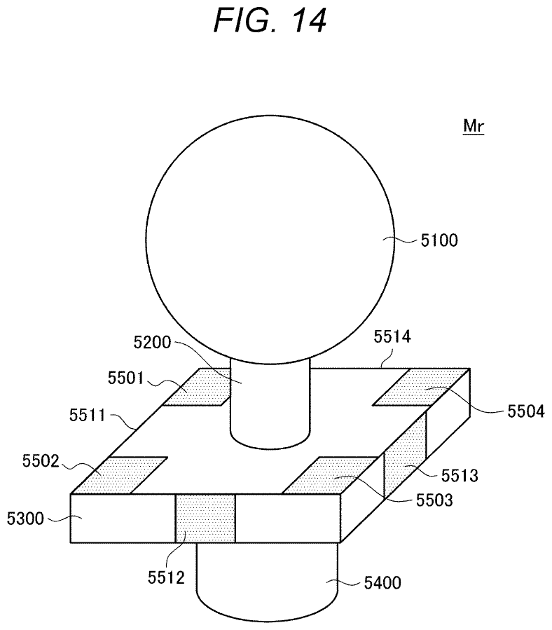

The mirror-finished body Mr is a jig having a mirror-finished surface and reflecting the environment on the user Us side on the surface. For example, the mirror-finished body Mr may have a configuration illustrated in FIG. 14. FIG. 14 is a schematic perspective view illustrating the configuration of the mirror-finished body Mr.

As illustrated in FIG. 14, the mirror-finished body Mr includes a mirror ball 5100, a pillar 5200, a base 5300, and a handle 5400.

The mirror ball 5100 is a spherical body whose surface is polished in a mirror surface shape. The mirror ball 5100 can reflect an image of the environment on the user Us side on the surface. The pillar 5200 is a member that connects the mirror ball 5100 and the base 5300. The base 5300 is provided in a flat plate shape below the pillar 5200. The handle 5400 is a member that the user Us grips when holding the mirror-finished body Mr, and is provided below the base 5300.

Furthermore, the base 5300 may include markers 5501, 5502, 5503, 5504, 5511, 5512, 5513, and 5514 (hereinafter, it is also simply referred to as a marker 5500) for tracking the position and posture of the mirror ball 5100. The markers 5501, 5502, 5503, and 5504 may be provided at four corners of the upper surface of the base 5300, respectively. The markers 5511, 5512, 5513, and 5514 may be provided on each side surface of the base 5300. The markers 5501, 5502, 5503, 5504, 5511, 5512, 5513, and 5514 are assumed to be mutually unique markers.

The sensor unit 501 includes an imaging device that images the line-of-sight direction of the user Us. The image captured by the sensor unit 501 is displayed on the display unit 502 as a video see-through image. Furthermore, the image captured by the sensor unit 501 is also used by the tracking unit 503 to estimate the positional relationship between the sensor unit 501 and the mirror-finished body Mr. Moreover, the image of the surface portion of the mirror-finished body Mr in the image captured by the sensor unit 501 is used as an environment image mapped on each surface of the cube map.

The tracking unit 503 estimates the positional relationship between the sensor unit 501 and the mirror-finished body Mr using the image captured by the sensor unit 501. As an example, in a case where the mirror-finished body Mr includes the marker 5500, the tracking unit 503 may estimate the positional relationship between the sensor unit 501 and the mirror-finished body Mr by tracking the marker 5500 whose positional relationship is known. As another example, the tracking unit 503 may estimate the positional relationship between the sensor unit 501 and the mirror-finished body Mr by tracking the three-dimensional shape of the mirror-finished body Mr. For tracking the three-dimensional shape of the mirror-finished body Mr, various methods such as feature amount detection, machine learning recognition, and contour shape detection can be used.

The map storage unit 504, the asset storage unit 505, the control unit 506, the drawing unit 507, and the display unit 502 are substantially similar to the map storage unit 204, the asset storage unit 205, the control unit 206, the drawing unit 207, and the display unit 202 described in the first embodiment, and thus description thereof is omitted here.

According to the above configuration, the information processing device 500 according to the present embodiment allows the user Us to visually recognize the virtual object Ob in which the environment image reflected on the surface of the mirror-finished body Mr is superimposed on the surface.

### (5.2. Operation)

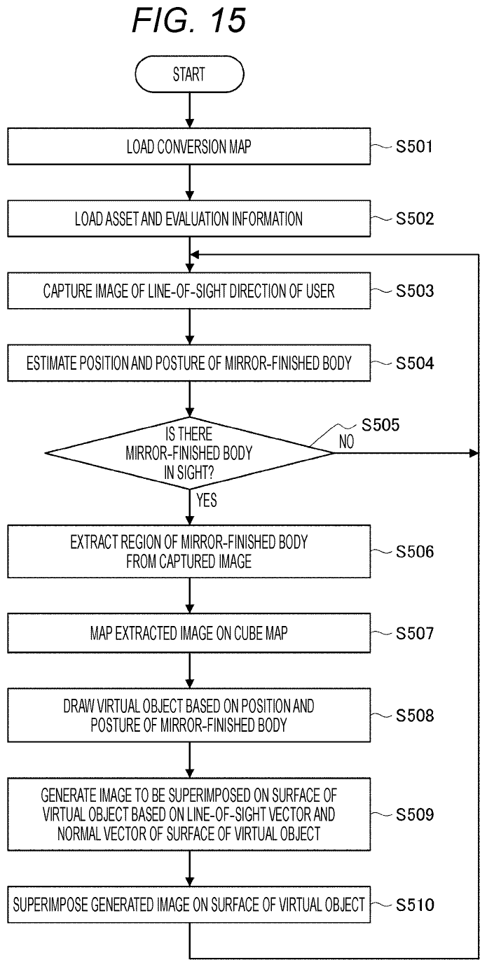

Subsequently, an operation example of the information processing device 500 according to the present embodiment will be described with reference to FIG. 15. FIG. 15 is a flowchart illustrating a flow of operation of the information processing device 500 according to the present embodiment.

As illustrated in FIG. 15, first, the control unit 506 reads the cube conversion map from the map storage unit 504 (S501). Next, the control unit 506 reads the asset information and the evaluation information of the virtual object Ob from the asset storage unit 505 (S502). Subsequently, the sensor unit 501 captures an image in the line-of-sight direction of the user Us (S503). In the present embodiment, the imaging direction by the sensor unit 501 is the line-of-sight direction of the user Us.

Next, the tracking unit 503 estimates the positional relationship between the sensor unit 501 and the mirror-finished body Mr on the basis of the image captured by the sensor unit 501 (S504). The tracking unit 503 may track the position and posture of the mirror-finished body Mr using the marker 5500 included in the mirror-finished body Mr, or may track the position and posture of the mirror-finished body Mr using the three-dimensional shape of the mirror-finished body Mr.

However, in a case where the mirror-finished body Mr does not exist in the image captured by the sensor unit 501 and the positional relationship between the sensor unit 501 and the mirror-finished body Mr cannot be estimated (S505/No), the sensor unit 501 may return to step S503 and image the line-of-sight direction of the user Us again.

Thereafter, the control unit 506 extracts a region corresponding to the surface of the mirror-finished body Mr from the image captured by the sensor unit 501 (S506). Subsequently, the control unit 506 maps the image of the extracted region on the cube map using the position and posture of the mirror-finished body Mr and the cube conversion map (S507).

Thereafter, the drawing unit 507 draws the virtual object Ob at an arbitrary relative position with the mirror-finished body Mr (S508), generates an image to be superimposed on the surface of the virtual object Ob (S509), and superimposes the generated image on the surface of the virtual object Ob (S510). Since the operations in steps S508 to S510 are substantially similar to the operations in steps S206 to S208 in the first embodiment, detailed description thereof is omitted here.

By repeating the operations in steps S503 to S510 described above for each frame, the information processing device 500 can reflect the environment image reflected in the mirror-finished body Mr on the surface of the virtual object Ob.

### 6. Fifth Embodiment

### (6.1. Configuration)

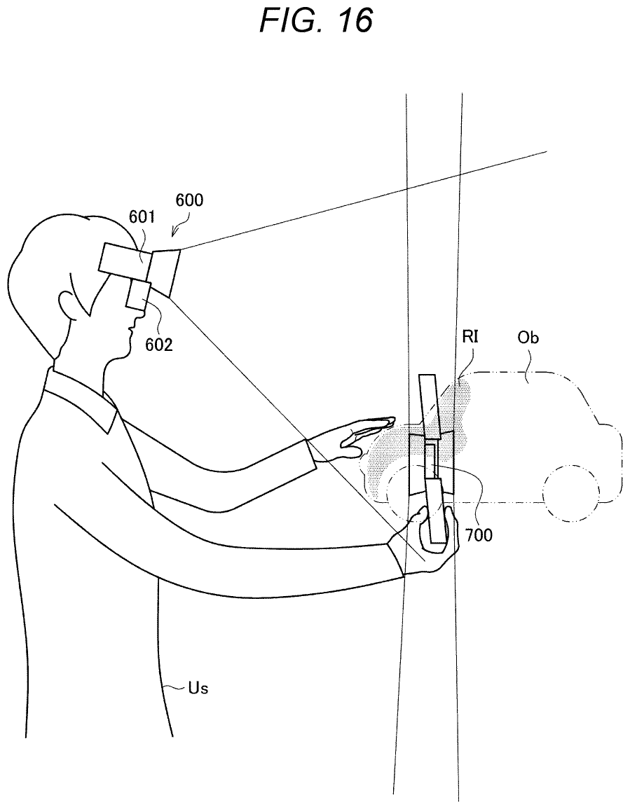

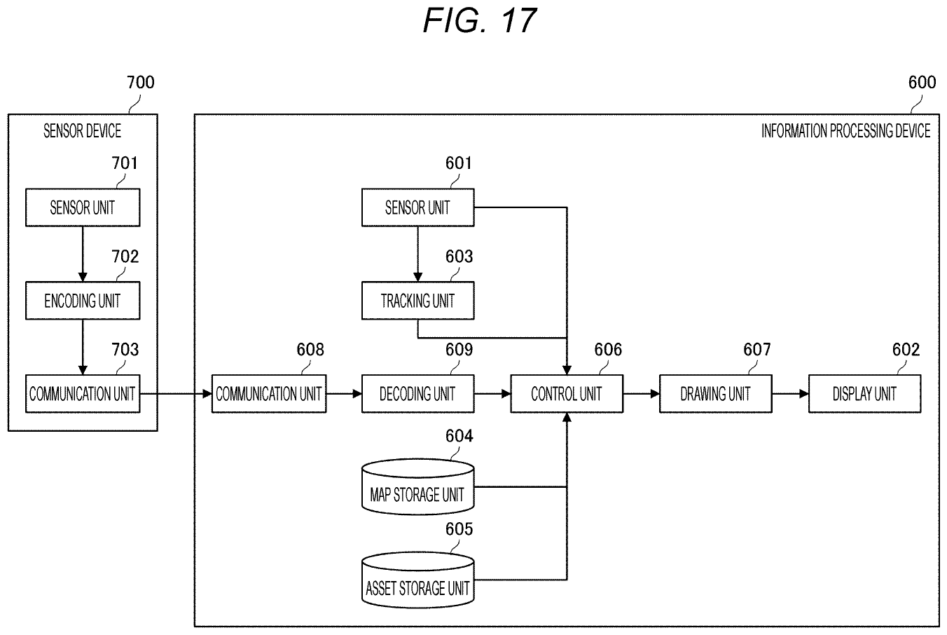

Subsequently, a configuration of an information processing device according to a fifth embodiment of the present disclosure will be described with reference to FIGS. 16 and 17. FIG. 16 is a schematic diagram illustrating an outline of an information processing device 600 according to the present embodiment.

As illustrated in FIG. 16, the information processing device 600 according to the present embodiment can be applied to an XR technology using the HMD. The user Us can visually recognize the virtual object Ob superimposed on the image captured by a sensor unit 601 via a display unit 602 of the HMD. At this time, the environment image RI captured by an external sensor device 700 is superimposed on the surface of the virtual object Ob.

The virtual object Ob illustrated in FIG. 16 is drawn by the information processing device 600 illustrated in FIG. 17. FIG. 17 is a block diagram illustrating the functional configuration of the information processing device 600 according to the present embodiment.

As illustrated in FIG. 17, the sensor device 700 includes a sensor unit 701, an encoding unit 702, and a communication unit 703. The information processing device 600 includes a sensor unit 601, a tracking unit 603, a communication unit 608, a map storage unit 604, an asset storage unit 605, a decoding unit 609, a control unit 606, a drawing unit 607, and a display unit 602.

### (Sensor Device 700)

The sensor unit 701 includes an imaging device that captures an image of the surrounding environment including the user Us side. For example, the sensor unit 701 may include an imaging device including a fisheye lens having a wide viewing angle, or may include an imaging device capable of imaging the entire 360°. The image captured by the sensor unit 701 is used as an environment image mapped to each surface of the cube map.

The encoding unit 702 encodes an image captured by the sensor unit 701. The encoding unit 702 may be, for example, a hardware encoder that encodes a captured image with a known codec.

The communication unit 703 transmits and receives data to and from the information processing device 600. For example, the communication unit 703 may transmit the image encoded by the encoding unit 702 to the information processing device 600 by using wired communication or wireless communication.

### (Information Processing Device 600)

The communication unit 608 transmits and receives data to and from the sensor device 700. For example, the communication unit 608 may receive the image encoded by the encoding unit 702 from the sensor device 700 by using wired communication or wireless communication.

The decoding unit 609 decodes the image received from the sensor device 700. The decoding unit 609 may decode the captured image by a known codec corresponding to the encoding unit 702.

The sensor unit 601 includes an imaging device that images the line-of-sight direction of the user Us. The image captured by the sensor unit 601 is displayed on the display unit 602 as a video see-through image. Furthermore, the image captured by the sensor unit 601 is also used by the tracking unit 603 to estimate the positional relationship between the sensor unit 601 and the sensor device 700.

The tracking unit 603 estimates a positional relationship between the sensor unit 601 and the sensor device 700 using an image captured by the sensor unit 601. As an example, in a case where the sensor device 700 includes a marker, the tracking unit 603 may estimate the positional relationship between the sensor unit 501 and the sensor device 700 by tracking a marker whose positional relationship is known. As another example, the tracking unit 603 may estimate the positional relationship between the sensor unit 601 and the sensor device 700 by tracking the three-dimensional shape of the sensor device 700. For tracking the three-dimensional shape of the sensor device 700, various methods such as feature amount detection, machine learning recognition, and contour shape detection can be used.

The map storage unit 604, the asset storage unit 605, the control unit 606, the drawing unit 607, and the display unit 602 are substantially similar to the map storage unit 204, the asset storage unit 205, the control unit 206, the drawing unit 207, and the display unit 202 described in the first embodiment, and thus description thereof is omitted here.

According to the above configuration, the information processing device 600 according to the present embodiment allows the user Us to visually recognize the virtual object Ob on which the environment image captured by the external sensor device 700 is superimposed on the surface.

### (6.2. Operation)

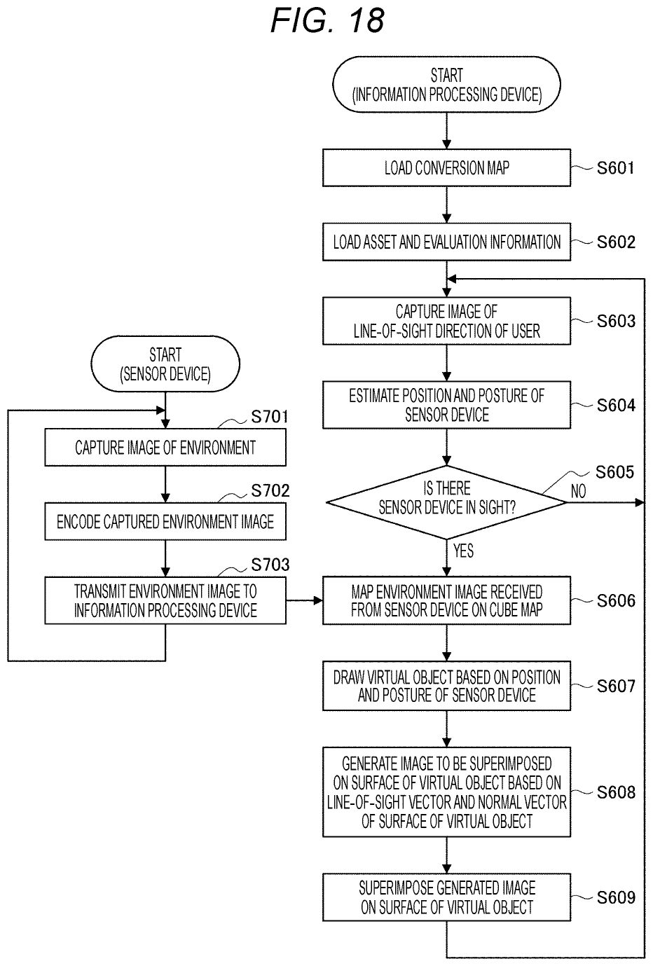

Subsequently, an operation example of the information processing device 600 and the sensor device 700 according to the present embodiment will be described with reference to FIG. 18. FIG. 18 is a flowchart illustrating a flow of operation of the information processing device 600 and the sensor device 700 according to the present embodiment.

As illustrated in FIG. 18, first, the sensor unit 701 of the sensor device 700 images the surrounding environment including the user Us side (S701). Next, the encoding unit 702 encodes the captured environment image (S702). Thereafter, the communication unit 703 transmits the encoded environment image to the information processing device 600 (S703).

On the other hand, the control unit 606 of the information processing device 600 reads the cube conversion map from the map storage unit 604 (S601). Next, the control unit 606 reads the asset information and the evaluation information of the virtual object Ob from the asset storage unit 605 (S602). Subsequently, the sensor unit 601 captures an image in the line-of-sight direction of the user Us (S603). In the present embodiment, the imaging direction by the sensor unit 601 is the line-of-sight direction of the user Us.

Next, the tracking unit 603 estimates the positional relationship between the sensor unit 601 and the sensor device 700 on the basis of the image captured by the sensor unit 601 (S604). The tracking unit 603 may track the position and posture of the sensor device 700 using a marker included in the sensor device 700, or may track the position and posture of the sensor device 700 using a three-dimensional shape of the sensor device 700.

However, in a case where the sensor device 700 does not exist in the image captured by the sensor unit 601 and the positional relationship between the sensor unit 601 and the sensor device 700 cannot be estimated (S605/No), the sensor unit 601 may return to step S603 and image the line-of-sight direction of the user Us again.

Thereafter, the control unit 606 maps the environment image received from the sensor device 700 on the cube map by using the position and posture of the sensor device 700 and the cube conversion map (S606).

Thereafter, the drawing unit 607 draws the virtual object Ob at an arbitrary relative position with the sensor device 700 (S607), generates an image to be superimposed on the surface of the virtual object Ob (S608), and superimposes the generated image on the surface of the virtual object Ob (S609). Since the operations in steps S607 to S609 are substantially similar to the operations in steps S206 to S208 in the first embodiment, detailed description thereof is omitted here.

By repeating the operations in steps S603 to S609 described above for each frame, the information processing device 600 can reflect the environment image captured by the sensor device 700 on the surface of the virtual object Ob.

### (6.3. Modifications)

### (First Modification)

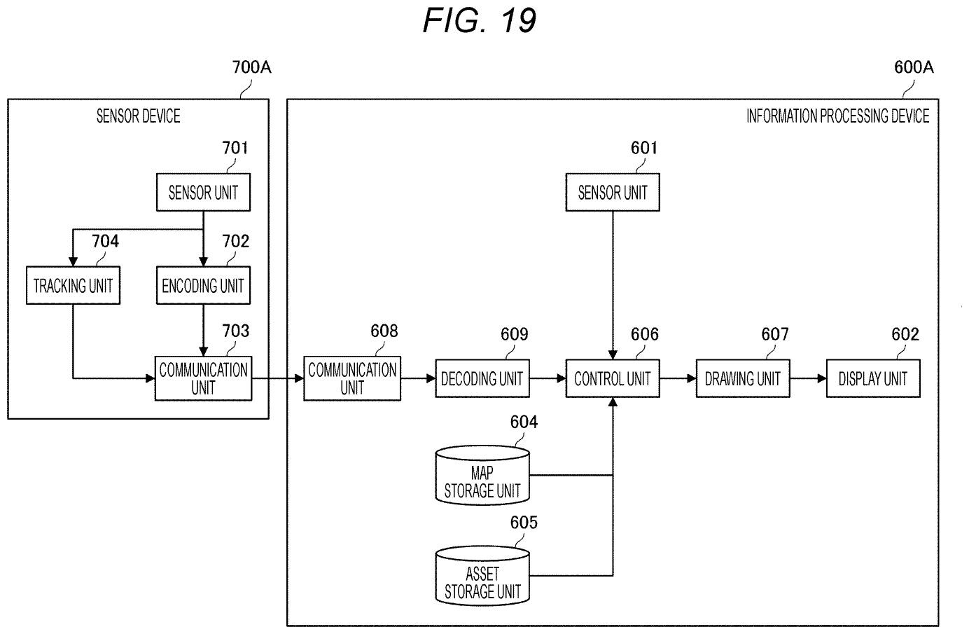

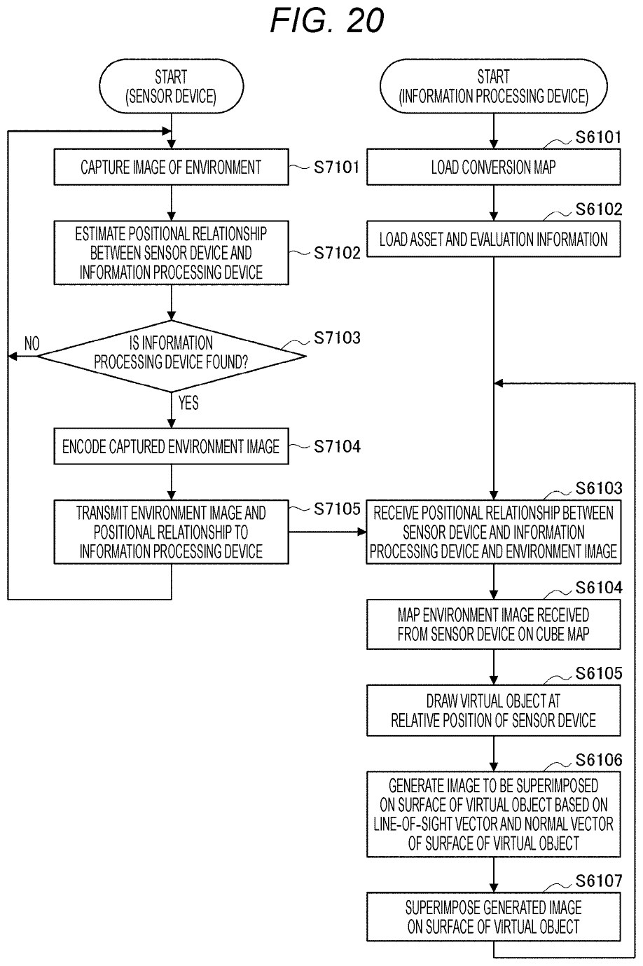

Moreover, an information processing device according to a first modification of the present embodiment will be described with reference to FIGS. 19 and 20. FIG. 19 is a block diagram illustrating functional configurations of an information processing device 600A and a sensor device 700A according to the first modification of the present embodiment.

The first modification is different from the sensor device 700 and the information processing device 600 illustrated in FIG. 17 in that a positional relationship between the sensor device 700A and the information processing device 600A is tracked by the sensor device 700A.

As illustrated in FIG. 19, the sensor device 700A further includes a tracking unit 704. The tracking unit 704 estimates a positional relationship between the sensor unit 701 and the information processing device 600A using an image captured by the sensor unit 701. As an example, in a case where the information processing device 600A includes a marker, the tracking unit 704 may estimate the positional relationship between the sensor unit 701 and the information processing device 600A by tracking a marker whose positional relationship is known. As another example, the tracking unit 704 may estimate the positional relationship between the sensor unit 701 and the information processing device 600A by tracking the three-dimensional shape of the information processing device 600A. For tracking the three-dimensional shape of the information processing device 600A, various methods such as feature amount detection, machine learning recognition, and contour shape detection can be used.

According to the first modification, since the information processing device 600A can reduce the functional configuration, it is possible to further reduce the size and weight.

Subsequently, operation examples of the information processing device 600A and the sensor device 700A according to the first modification will be described with reference to FIG. 20. FIG. 20 is a flowchart illustrating a flow of operations of the information processing device 600A and the sensor device 700A according to the first modification.

As illustrated in FIG. 20, first, the sensor unit 701 of the sensor device 700A images the surrounding environment including the user Us side (S7101). Next, the tracking unit 704 estimates the positional relationship between the sensor unit 701 and the information processing device 600A on the basis of the image captured by the sensor unit 701 (S7102). The tracking unit 704 may track the position and posture of the information processing device 600A using the marker included in the information processing device 600A, or may track the position and posture of the information processing device 600A using the three-dimensional shape of the information processing device 600A.

However, in a case where the information processing device 600A does not exist in the image captured by the sensor unit 701 and the positional relationship between the sensor unit 701 and the information processing device 600A cannot be estimated (S7103/No), the sensor unit 701 may return to step S7101 and image the surrounding environment including the user Us side again.

Next, the encoding unit 702 encodes the captured environment image (S7104). Thereafter, the communication unit 703 transmits the environment image and the positional relationship between the sensor device 700A and the information processing device 600A to the information processing device 600A (S7105).

On the other hand, the control unit 606 of the information processing device 600A reads the cube conversion map from the map storage unit 604 (S6101). Next, the control unit 606 reads the asset information and the evaluation information of the virtual object Ob from the asset storage unit 605 (S6102).

Subsequently, the communication unit 608 receives the environment image and the positional relationship between the sensor device 700A and the information processing device 600A from the sensor device 700A (S6103). Moreover, the control unit 606 maps the environment image received from the sensor device 700A on the cube map by using the positional relationship between the sensor device 700A and the information processing device 600A and the cube conversion map (S6104).

Thereafter, the drawing unit 607 draws the virtual object Ob at an arbitrary relative position with the sensor device 700A (S6105), generates an image to be superimposed on the surface of the virtual object Ob (S6106), and superimposes the generated image on the surface of the virtual object Ob (S6107).

By repeating the operations in steps S6103 to S6107 described above for each frame, the information processing device 600A can reflect the environment image captured by the sensor device 700A on the surface of the virtual object Ob.

### (Second Modification)

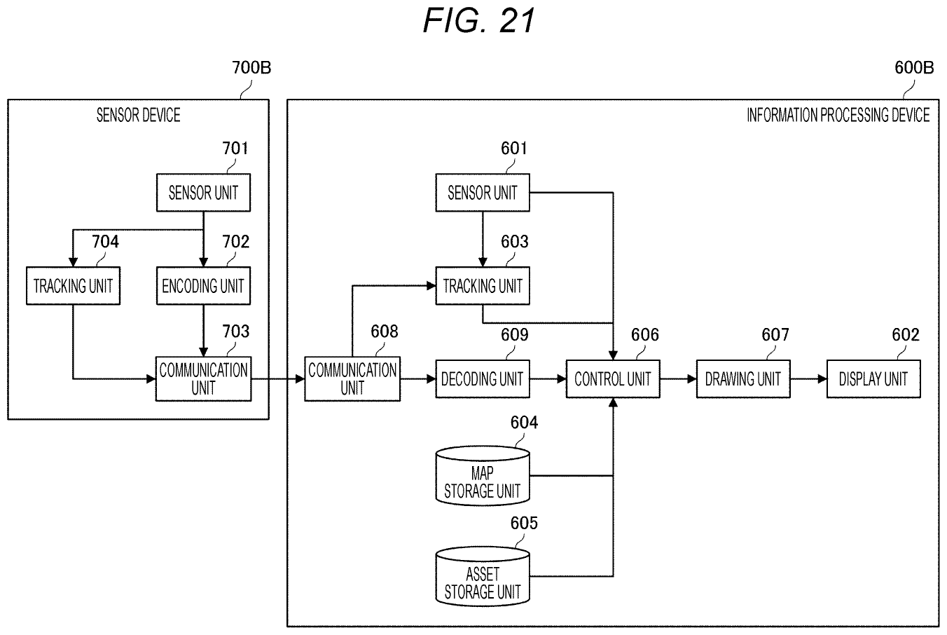

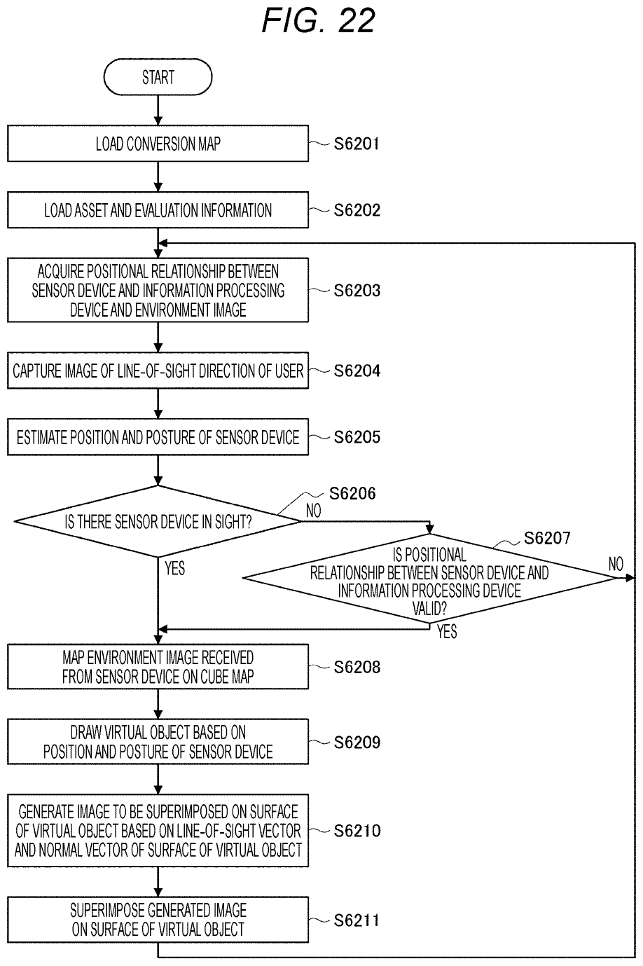

Next, an information processing device according to a second modification of the present embodiment will be described with reference to FIGS. 21 and 22. FIG. 21 is a block diagram illustrating functional configurations of an information processing device 600B and a sensor device 700B according to the second modification of the present embodiment.

The second modification is different from the sensor device 700 and the information processing device 600 illustrated in FIG. 17 in that positional relationships are tracked between the information processing device 600B and the sensor device 700B.

As illustrated in FIG. 21, the sensor device 700B further includes a tracking unit 704. The tracking unit 704 can estimate the positional relationship between the sensor unit 701 and the information processing device 600B using the image captured by the sensor unit 701.

Furthermore, the information processing device 600B includes a tracking unit 603. The tracking unit 603 estimates a positional relationship between the sensor unit 601 and the sensor device 700B using an image captured by the sensor unit 601. In a case where it is difficult to estimate the positional relationship between the sensor unit 601 and the sensor device 700B in the image captured by the sensor unit 601, the information processing device 600B can refer to the positional relationship between the sensor unit 701 and the information processing device 600B estimated by the sensor device 700B.

According to the second modification, the information processing device 600B can estimate the positional relationship between the information processing device 600B and the sensor device 700B with reference to the tracking result of the information processing device 600B in the sensor device 700B. Therefore, the information processing device 600B can further suppress loss of the positional relationship between the information processing device 600B and the sensor device 700B.

Subsequently, operation examples of the information processing device 600B and the sensor device 700B according to the second modification will be described with reference to FIG. 22. FIG. 22 is a flowchart illustrating a flow of operations of the information processing device 600B and the sensor device 700B according to the second modification.

As illustrated in FIG. 22, the control unit 606 of the information processing device 600B reads the cube conversion map from the map storage unit 604 (S6201). Next, the control unit 606 reads the asset information and the evaluation information of the virtual object Ob from the asset storage unit 605 (S6202).

Subsequently, the communication unit 608 receives the environment image and the positional relationship between the sensor device 700B and the information processing device 600B from the sensor device 700B (S6203).

Next, the sensor unit 601 captures an image in the line-of-sight direction of the user Us (S6204). Subsequently, the tracking unit 603 estimates the positional relationship between the sensor unit 601 and the sensor device 700B on the basis of the image captured by the sensor unit 601 (S6205). The tracking unit 603 may track the position and posture of the sensor device 700B using the marker included in the sensor device 700B, or may track the position and posture of the sensor device 700B using the three-dimensional shape of the sensor device 700B.

However, in a case where the sensor device 700B does not exist in the image captured by the sensor unit 601 and the positional relationship between the sensor unit 601 and the sensor device 700B cannot be estimated (S6206/No), the information processing device 600B determines whether or not the positional relationship between the sensor device 700B and the information processing device 600B received from the sensor device 700B is valid (S6207).

In a case where the positional relationship between the sensor device 700B and the information processing device 600B received from the sensor device 700B is not valid (S6207/No), the sensor unit 601 may return to step S6203 and image the line-of-sight direction of the user Us again. On the other hand, in a case where the positional relationship between the sensor device 700B and the information processing device 600B received from the sensor device 700B is valid (S6207/Yes), the tracking unit 603 recognizes the positional relationship between the sensor device 700B and the information processing device 600B received from the sensor device 700B as correct.

Thereafter, the control unit 606 maps the environment image received from the sensor device 700B on the cube map by using the positional relationship between the sensor device 700B and the information processing device 600B recognized as correct and the cube conversion map (S6208). The positional relationship between the sensor device 700B and the information processing device 600B at this time may be a positional relationship estimated by the tracking unit 603 on the basis of an image captured by the sensor unit 601, or may be a positional relationship received from the sensor device 700B.

Thereafter, the drawing unit 607 draws the virtual object Ob at an arbitrary relative position with the sensor device 700B (S6209), generates an image to be superimposed on the surface of the virtual object Ob (S6210), and superimposes the generated image on the surface of the virtual object Ob (S6211).

By repeating the operations in steps S6203 to S6211 described above for each frame, the information processing device 600B can reflect the environment image captured by the sensor device 700B on the surface of the virtual object Ob.

### (Third Modification)

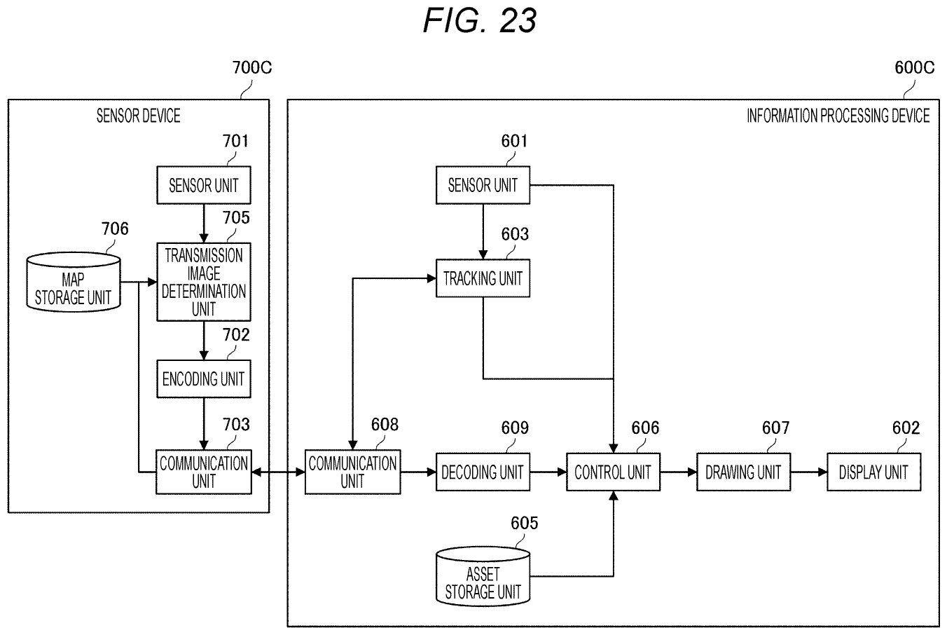

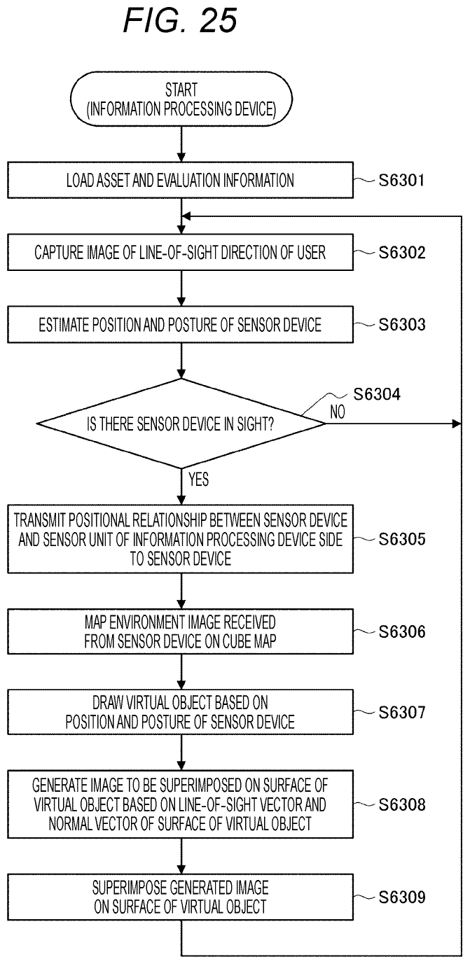

Subsequently, an information processing device according to a third modification of the present embodiment will be described with reference to FIGS. 23 and 25. FIG. 23 is a block diagram illustrating functional configurations of an information processing device 600C and a sensor device 700C according to the third modification of the present embodiment.

In the third modification, a map storage unit 706 and a transmission image determination unit 705 are further provided in the sensor device 700C. The sensor device 700C according to the third modification is different from the sensor device 700 and the information processing device 600 illustrated in FIG. 17 in that the range of the image transmitted from the sensor device 700C to the information processing device 600C is controlled on the basis of the acceleration applied to the sensor device 700C.

As illustrated in FIG. 23, the sensor device 700C further includes a map storage unit 706 and a transmission image determination unit 705.

The map storage unit 706 stores the cube conversion map that uniquely determines the correspondence relationship between the coordinates on the hemispherical coordinate system of the environment image and the coordinates on the cube map coordinate system. The cube conversion map is data indicating a correspondence relationship between the position of each pixel of the environment image to be mapped and the position of each face of the cube map.

The transmission image determination unit 705 determines a range of an image to be transmitted to the information processing device 600C on the basis of the acceleration applied to the sensor device 700C. Specifically, the transmission image determination unit 705 first determines whether or not the acceleration applied to the sensor device 700C exceeds a threshold. If the acceleration applied to the sensor device 700C exceeds the threshold, the transmission image determination unit 705 determines to transmit the entire image captured by the sensor unit 701 to the information processing device 600C as usual. On the other hand, when the acceleration applied to the sensor device 700C does not exceed the threshold, the transmission image determination unit 705 determines to transmit a part of the image captured by the sensor unit 701 to the information processing device 600C.

This is because, in a case where the change in the position and posture of the sensor device 700C is small, it is considered that the change in the positional relationship between the sensor device 700C and the information processing device 600C is small. Therefore, the sensor device 700C can update the environment image to be superimposed on the virtual object Ob by transmitting only a part of the image centered on the sensor unit 601 of the information processing device 600C to the information processing device 600C. For example, the transmission image determination unit 705 may determine to extract a region of 180° vertically and horizontally around the direction in which the information processing device 600C is viewed from the sensor unit 701 and transmit an image of the extracted region to the information processing device 600C.

According to the third modification, the sensor device 700C can reduce the amount of data communicated with the information processing device 600C.

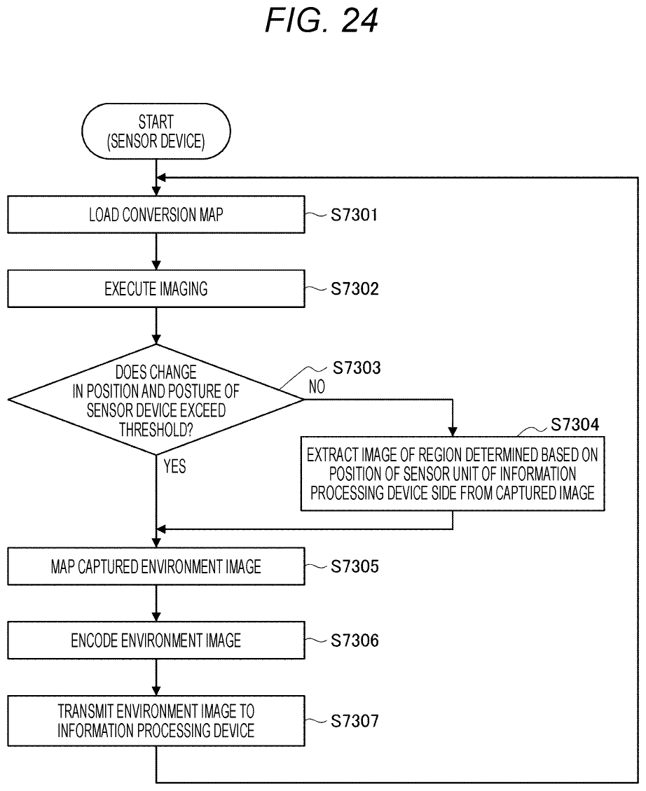

Moreover, operation examples of the information processing device 600A and the sensor device 700A according to the third modification will be described with reference to FIGS. 24 and 25. FIG. 24 is a flowchart illustrating a flow of operation of the sensor device 700C according to the third modification. FIG. 25 is a flowchart illustrating a flow of operation of the information processing device 600C according to the third modification.

As illustrated in FIG. 24, first, the transmission image determination unit 705 of the sensor device 700C reads the cube conversion map from the map storage unit 706 (S7301). Next, the sensor unit 701 executes imaging (S7302). Here, the transmission image determination unit 705 determines whether or not the change in the position and posture of the sensor device 700C exceeds the threshold on the basis of a measurement result of an internal sensor such as an IMU (not illustrated) (S7303).

In a case where the change in the position and posture of the sensor device 700C does not exceed the threshold (S7303/No), the transmission image determination unit 705 extracts an image of a region of a predetermined range (for example, 180° vertically and horizontally) centered on the sensor unit 601 of the information processing device 600C from the image captured by the sensor unit 701 (S7304).

Subsequently, the transmission image determination unit 705 maps the entire image captured by the sensor unit 701 or the image of the region extracted in step S7304 onto the cube map (S7305). Next, the encoding unit 702 encodes the mapped environment image (S7306). Thereafter, the communication unit 703 transmits the encoded environment image to the information processing device 600C (S7307).

On the other hand, as illustrated in FIG. 25, first, the control unit 606 of the information processing device 600C reads the asset information and the evaluation information of the virtual object Ob from the asset storage unit 605 (S6301). Subsequently, the sensor unit 601 captures an image in the line-of-sight direction of the user Us (S6302). Next, the tracking unit 603 estimates the positional relationship between the sensor unit 601 and the sensor device 700C on the basis of the image captured by the sensor unit 601 (S6303). The tracking unit 603 may track the position and posture of the sensor device 700C using the marker included in the sensor device 700C, or may track the position and posture of the sensor device 700C using the three-dimensional shape of the sensor device 700C.

However, in a case where the sensor device 700C does not exist in the image captured by the sensor unit 601 and the positional relationship between the sensor unit 601 and the sensor device 700C cannot be estimated (S6304/No), the sensor unit 601 may return to step S6302 and image the line-of-sight direction of the user Us again.

Thereafter, the communication unit 608 transmits the positional relationship between the sensor device 700C and the sensor unit 601 to the sensor device 700C (S6305). Subsequently, the drawing unit 607 updates the texture of each surface of the cube map with the environment image received from the sensor device 700C (S6306).

Next, the drawing unit 607 draws the virtual object Ob at an arbitrary relative position with the sensor device 700C (S6307), generates an image to be superimposed on the surface of the virtual object Ob (S6308), and superimposes the generated image on the surface of the virtual object Ob (S6309).

By repeating the operations in steps S6302 to S6309 described above for each frame, the information processing device 600C can reflect the environment image captured by the sensor device 700C on the surface of the virtual object Ob.

### (Fourth Modification)

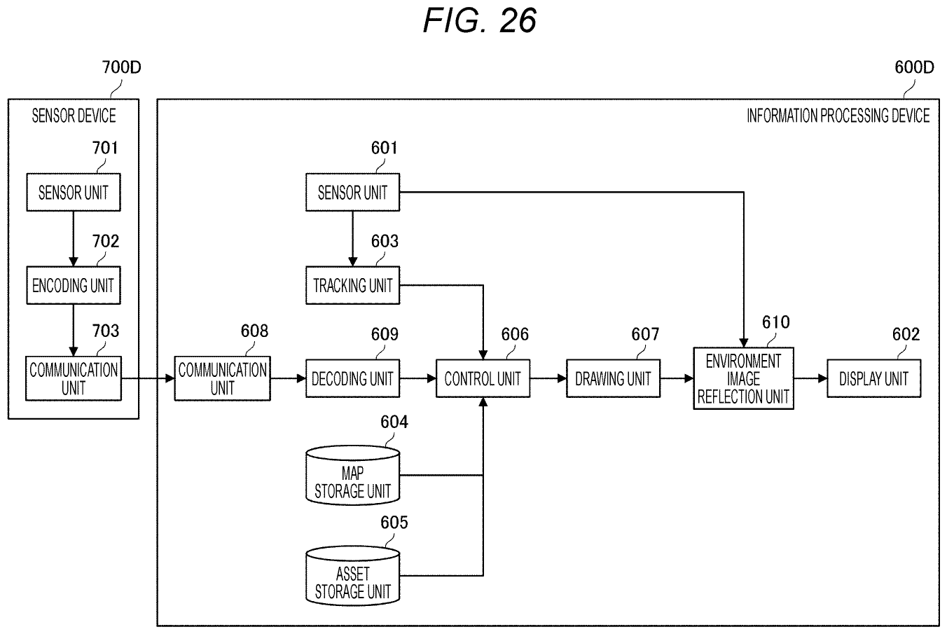

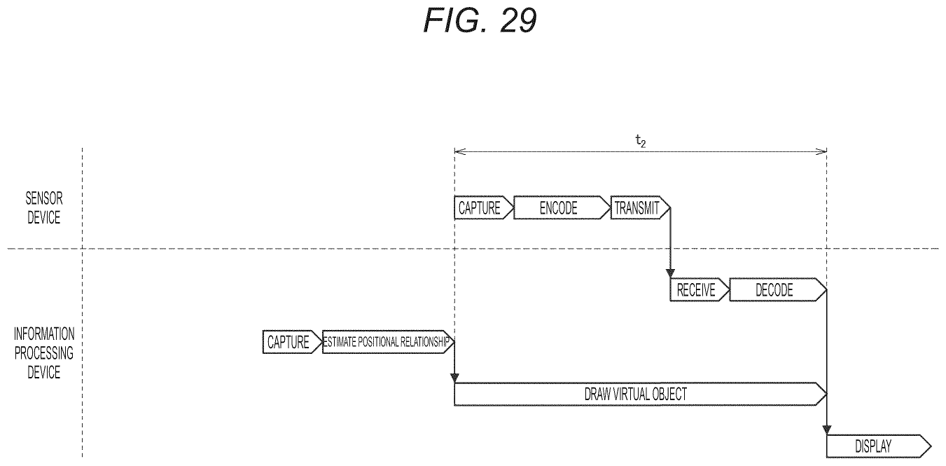

Next, an information processing device according to a fourth modification of the present embodiment will be described with reference to FIGS. 26 and 29. FIG. 26 is a block diagram illustrating functional configurations of an information processing device 600D and a sensor device 700D according to the fourth modification of the present embodiment.

In the fourth modification, the time from the transmission of the environment image captured by the sensor device 700D to the information processing device 600D to the superimposition on the surface of the virtual object Ob can be shortened, and the image to be superimposed on the surface of the virtual object Ob can be generated using the latest environment image immediately before the display.

Specifically, as illustrated in FIG. 26, the information processing device 600D further includes an environment image reflection unit 610.

First, the drawing unit 607 derives a reflection vector obtained by reflecting the line-of-sight vector of the user Us on the surface of the virtual object Ob on the basis of the line-of-sight direction of the user Us and the normal vector of the surface of the virtual object Ob. Moreover, the drawing unit 607 generates a reference map by storing intersections between the derived reflection vector and each surface of the cube map in a buffer. That is, the surface of the virtual object Ob and the point on each surface of the cube map on which the environment image to be superimposed on the surface of the virtual object Ob is mapped are associated with each other in the reference map.

The environment image reflection unit 610 first maps the environment image captured by the sensor unit 701 of the sensor device 700D on the cube map. Therefore, the environment image reflection unit 610 can determine the environment image to be superimposed on the surface of the virtual object Ob from the environment image mapped on the cube map by referring to the correspondence relationship of the reference map generated by the drawing unit 607. Moreover, the environment image reflection unit 610 can generate the image of the virtual object Ob displayed on the display unit 602 by superimposing the determined environment image on the surface of the virtual object Ob.

According to the fourth modification, since the surface of the virtual object Ob and the pixel position of the environment image to be superimposed on the surface can be associated in advance, it is possible to further shorten the delay from the imaging of the environment image in the sensor device 700D to the superimposition of the environment image on the surface of the virtual object Ob.

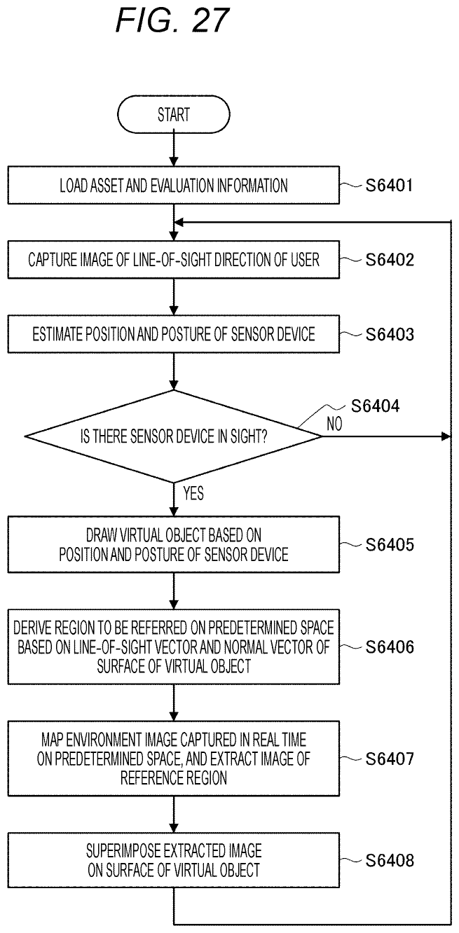

Next, an operation example of the information processing device 600D according to the fourth modification will be described with reference to FIG. 27. FIG. 27 is a flowchart illustrating a flow of operation of the information processing device 600D according to the fourth modification.

As illustrated in FIG. 27, first, the control unit 606 reads the asset information and the evaluation information of the virtual object Ob from the asset storage unit 605 (S6401). Next, the sensor unit 601 captures an image in the line-of-sight direction of the user Us (S6402). Subsequently, the tracking unit 603 estimates the positional relationship between the sensor unit 601 and the sensor device 700D on the basis of the image captured by the sensor unit 601 (S6403). The tracking unit 603 may track the position and posture of the sensor device 700D using the marker included in the sensor device 700D, or may track the position and posture of the sensor device 700D using the three-dimensional shape of the sensor device 700D.

However, in a case where the sensor device 700D does not exist in the image captured by the sensor unit 601 and the positional relationship between the sensor unit 601 and the sensor device 700D cannot be estimated (S6404/No), the sensor unit 601 may return to step S6402 and image the line-of-sight direction of the user Us again.

Next, the drawing unit 607 draws the virtual object Ob at an arbitrary relative position with the sensor device 700D (S6405). Here, the drawing unit 607 derives a reflection vector on the surface of the virtual object Ob on the basis of the line-of-sight direction of the user Us and the normal vector of the surface of the virtual object Ob, and generates a reference map in which an intersection between the derived reflection vector and each surface of the cube map is stored (S6406). The reference map is a map indicating a region to be referred to on the cube map when the environment image to be superimposed on the surface of the virtual object Ob is generated.

Thereafter, the environment image reflection unit 610 maps the environment image captured in real time on the cube map, thereby extracting the environment image to be superimposed on the surface of the virtual object Ob from the cube map on the basis of the reference map (S6407). Therefore, the environment image reflection unit 610 can superimpose the extracted environment image on the surface of the virtual object Ob (S6408).

By repeating the operations in steps S6402 to S6408 described above for each frame, the information processing device 600D can reflect the environment image captured in real time by the sensor device 700C on the surface of the virtual object Ob.

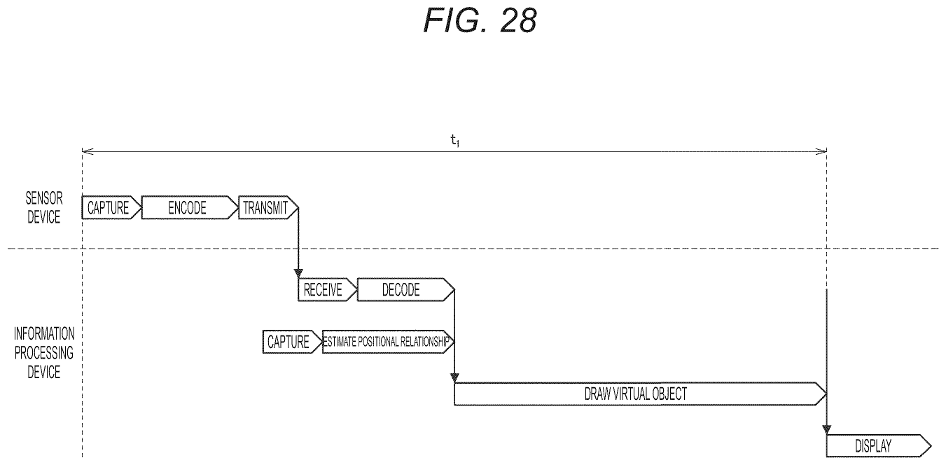

Here, timing charts of the information processing device 600D and the sensor device 700D according to the fourth modification will be described with reference to FIGS. 28 and 29. FIG. 28 is a timing chart of the information processing device 600 and the sensor device 700 according to the fifth embodiment. FIG. 29 is a timing chart of the information processing device 600D and the sensor device 700D according to the fourth modification.

As illustrated in FIG. 28, in the information processing device 600 and the sensor device 700 according to the fifth embodiment, first, an environment image is captured and encoded by the sensor device 700, and then the environment image is transmitted to the information processing device 600. Subsequently, after receiving and decoding the transmitted environment image, the information processing device 600 draws the virtual object in the three-dimensional space on the basis of the positional relationship with the sensor device 700, and superimposes the environment image on the surface of the virtual object.

That is, the information processing device 600 according to the fifth embodiment receives the environment image captured by the sensor device 700 in advance, draws the virtual object in the three-dimensional space on the basis of the positional relationship with the sensor device 700, and generates the image to be superimposed on the surface of the virtual object from the environment image.

On the other hand, as illustrated in FIG. 29, in the information processing device 600D and the sensor device 700D according to the fourth modification, the environment image is captured and encoded by the sensor device 700D in parallel with the drawing of the virtual object in the three-dimensional space by the information processing device 600D. Subsequently, the information processing device 600D receives and decodes the transmitted environment image, and superimposes the environment image on the surface of the virtual object associated in advance.

That is, the information processing device 600D according to the fourth modification associates the surface of the virtual object with the pixel position of the environment image to be superimposed on the surface in advance, so that it is possible to capture the environment image and draw the virtual object in parallel.

According to this, the information processing device 600D according to the fourth modification can greatly shorten the time t₂ from the imaging of the environment image to the displaying of the virtual object in which the environment image is superimposed on the surface, as compared with the same time t₁ of the information processing device 600 according to the fifth embodiment. Therefore, the information processing device 600D according to the fourth modification can generate an image to be superimposed on the surface of the virtual object Ob using the more recent environment image immediately before display.

### 7. Variations

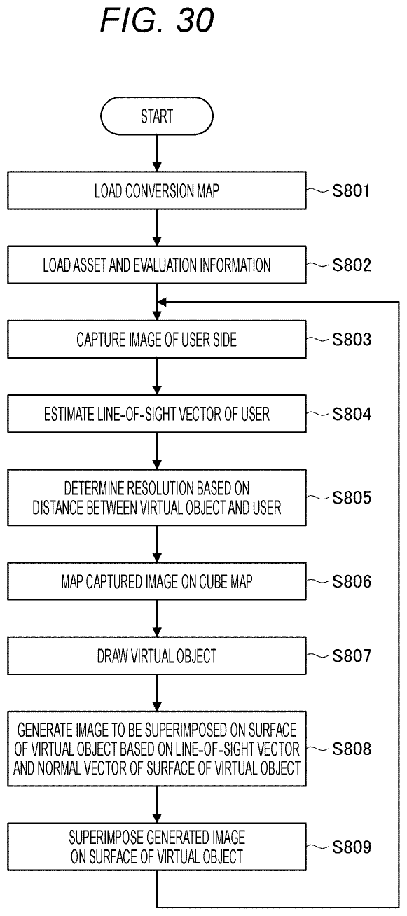

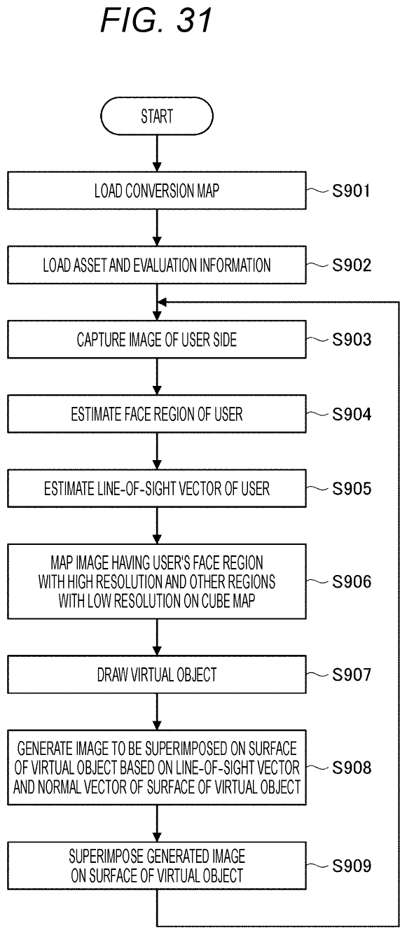

Moreover, in each embodiment of the present disclosure, it is also possible to change the resolution of the sensor unit that captures the environment image. Variations of changing the resolution of the sensor unit will be described with reference to FIGS. 30 and 31. In the following description, reference numerals of the components refer to the first embodiment.

### (7.1. First Variation)

FIG. 30 is a flowchart illustrating an operation example of controlling the resolution of the sensor unit 201 that captures the environment image according to the distance between the user Us and the virtual object Ob.

In embodiments using light field display or projection mapping as a display unit, the distance between the sensor unit and the user Us can be estimated by face detection or line-of-sight detection. For example, the size of the face of the user Us or the interocular distance generally falls within a certain range. Therefore, the information processing device 200 can estimate the distance between the sensor unit and the user Us from the image captured by the sensor unit by checking in advance the correspondence relationship between the size of the face of the user Us or the interocular distance in the image captured by the sensor unit and the distance between the sensor unit and the user Us. According to this, since the positional relationship between the sensor unit and the virtual object Ob is known, the information processing device 200 can estimate the distance between the user Us and the virtual object Ob via the sensor unit.

In an embodiment using a mobile terminal such as a smartphone or an HMD as a display unit, the distance between the sensor unit and the user Us can be derived by self-position estimation such as SLAM or position estimation by a marker. In the case of using SLAM, it is possible to directly estimate the distance between the virtual object and the user Us (strictly, the sensor unit) in the world coordinate system. In the case of using the position estimation by the marker, since the positional relationship between the marker and the sensor unit that tracks the marker can be directly estimated, the distance between the virtual object Ob arranged at the relative position of the marker and the user Us (strictly, the sensor unit) can be estimated.

Note that, in a case where a mobile terminal such as a smartphone is used as a display unit, the positional relationship between the mobile terminal provided with the sensor unit and the virtual object Ob can be estimated, but the positional relationship between the mobile terminal and the user Us is not exactly clear. However, since the positional relationship between the mobile terminal and the user Us generally falls within the range of the length of the arm of the user Us, it is possible to perform approximate estimation. Moreover, in a case where the face detection or the line-of-sight detection of the user Us can be performed on the mobile terminal, it is possible to estimate the distance between the mobile terminal and the user Us, similarly to the embodiment using the light-field display or the projection mapping as a display unit.

As illustrated in FIG. 30, the control unit 206 first reads the cube conversion map from the map storage unit 204 (S801). Next, the control unit 206 reads the asset information and the evaluation information of the virtual object Ob from the asset storage unit 205 (S802).

Subsequently, the sensor unit 201 captures an environment image of the user Us side (S803). Therefore, the self-position estimation unit 203 estimates the line-of-sight vector of the user Us on the basis of the captured environment image of the user Us side (S804). The line-of-sight vector of the user Us can be estimated using a known line-of-sight detection method.

Moreover, the self-position estimation unit 203 estimates the distance between the user Us and the sensor unit 201 on the basis of the captured environment image on the user Us side, and estimates the distance between the user Us and the virtual object Ob on the basis of the distance between the user Us and the sensor unit 201. Therefore, the control unit 206 can determine the resolution of the environment image captured by the sensor unit 201 on the basis of the distance between the user Us and the virtual object Ob (S805). The determined resolution of the environment image is output to the sensor unit 201 to be used for controlling the resolution of the sensor unit 201.

Furthermore, the drawing unit 207 maps the captured environment image of the user Us side on the cube map (S806). Thereafter, the drawing unit 207 draws the virtual object Ob at an arbitrary position in the world coordinates (S807), generates an image to be superimposed on the surface of the virtual object Ob (S808), and superimposes the generated image on the surface of the virtual object Ob (S809).

By repeating the operations in steps S803 to S809 described above for each frame, the information processing device 200 can reflect the environment image captured in real time by the sensor unit 201 on the surface of the virtual object Ob. Furthermore, the information processing device 200 can control the resolution of the environment image captured by the sensor unit 201 on the basis of the distance between the user Us and the virtual object Ob.

According to the present variation, the information processing device 200 can control the resolution of the environment image to be superimposed on the virtual object Ob such that the resolution becomes higher as the user Us is closer to the virtual object Ob. Therefore, the information processing device 200 can reduce the processing load of the calculation without greatly affecting the appearance of the environment image to be superimposed on the surface of the virtual object Ob.

### (7.2. Second Variation)

FIG. 31 is a flowchart illustrating an operation example of controlling the resolution of the environment image on the basis of the priority of the object included in the region of the environment image captured by the sensor. For example, in the following operation example, the resolution of the region in which the face of the user Us is reflected in the environment image is controlled to be higher than the resolution of the region in which the face of the user Us is not reflected.

As a method of discriminating a region in which the face of the user Us is reflected from the environment image, image recognition using machine learning, line-of-sight detection of the user, or the like can be used. Furthermore, as a method of discriminating a region in which the face of the user Us is reflected from the environment image, a method of discriminating a rectangular region centered on a point corresponding to the position of the eye of the user Us as a face region by applying the rectangular region to the three-dimensional position and posture of the user Us can be used.

As illustrated in FIG. 31, the control unit 206 first reads the cube conversion map from the map storage unit 204 (S901). Next, the control unit 206 reads the asset information and the evaluation information of the virtual object Ob from the asset storage unit 205 (S902).

Subsequently, the sensor unit 201 captures an environment image of the user Us side (S903). Next, the self-position estimation unit 203 estimates a face region of the user Us on the basis of the captured environment image of the user Us side (S904). Moreover, the self-position estimation unit 203 estimates the line-of-sight vector of the user Us on the basis of the captured environment image of the user Us side (S905). The line-of-sight vector of the user Us can be estimated using a known line-of-sight detection method.

Here, the drawing unit 207 maps the captured environment image of the user Us side on the cube map (S906). Specifically, the drawing unit 207 may map, on the cube map, an environment image in which a face region in which the face of the user Us is reflected has high resolution and other regions have low resolution. The high resolution at this time may indicate that the resolution is higher than the resolution of other regions, or may indicate that the resolution is higher than the resolution at the time of imaging. Similarly, the low resolution at this time may indicate that the resolution is lower than the resolution of other regions, or may indicate that the resolution is lower than the resolution at the time of imaging.

Thereafter, the drawing unit 207 draws the virtual object Ob at an arbitrary position in the world coordinates (S907), generates an image to be superimposed on the surface of the virtual object Ob (S908), and superimposes the generated image on the surface of the virtual object Ob (S909).

By repeating the operations in steps S903 to S909 described above for each frame, the information processing device 200 can reflect the environment image captured in real time by the sensor unit 201 on the surface of the virtual object Ob. Furthermore, the information processing device 200 can control the resolution of the environment image of the region including the main object such as the face of the user Us.

According to the present variation, while maintaining the resolution of the environment image of the region including the main object such as the face of the user Us, the information processing device 200 can reduce the resolution of the environment image of the other region and reflect the reduced resolution on the surface of the virtual object Ob. Therefore, the information processing device 200 can reduce the processing load of the calculation without greatly affecting the appearance of the environment image to be superimposed on the surface of the virtual object Ob.

### 8. Hardware Configuration

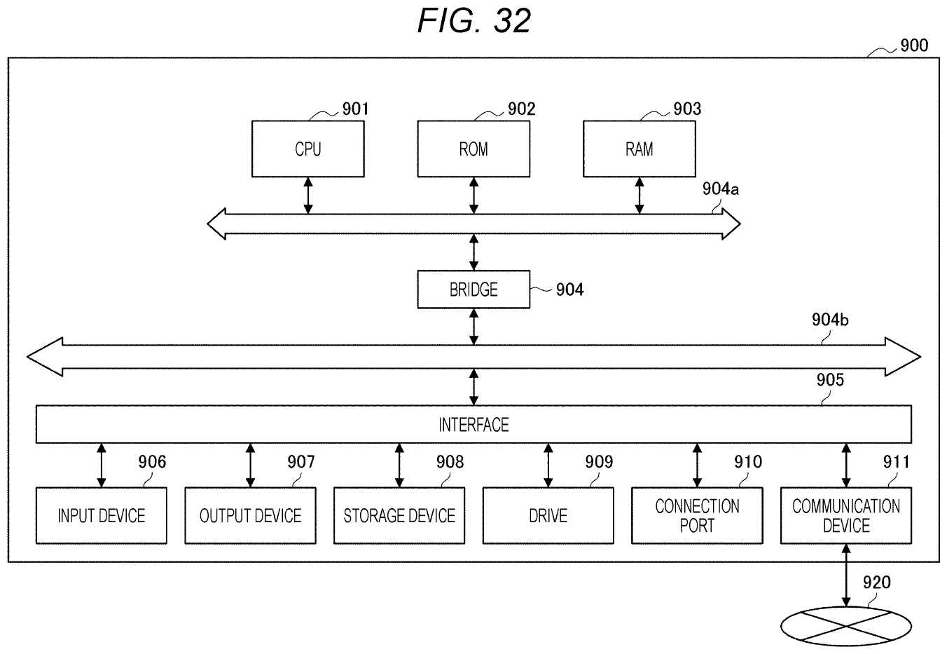

Moreover, a hardware configuration of the information processing device according to each embodiment of the present disclosure will be described with reference to FIG. 32. FIG. 32 is a block diagram illustrating exemplary hardware configuration of an information processing device according to each embodiment.

Functions of the information processing device according to each embodiment can be realized by cooperation of software and hardware described below. The control or calculation function of the information processing device may be realized by, for example, a CPU 901. Furthermore, the storage function of the information processing device may be realized by, for example, a storage device 908.

As illustrated in FIG. 32, an information processing device 900 includes a central processing unit (CPU) 901, a read only memory (ROM) 902, and a random access memory (RAM) 903.

Furthermore, the information processing device 900 may further include a host bus 904a, a bridge 904, an external bus 904b, an interface 905, an input device 906, an output device 907, a storage device 908, a drive 909, a connection port 910, or a communication device 911. Moreover, the information processing device 900 may include an imaging device and a sensor as necessary. The information processing device 900 may include a processing circuit such as a graphics processing unit (GPU), a digital signal processor (DSP), or an application specific integrated circuit (ASIC) instead of or in addition to the CPU 901.

The CPU 901 functions as an arithmetic processing device or a control device, and controls the operation of the information processing device 900 according to various programs recorded on a removable recording medium attached to the ROM 902, the RAM 903, the storage device 908, or the drive 909. The ROM 902 stores programs, calculation parameters, and the like used by the CPU 901. The RAM 903 temporarily stores a program used in execution by the CPU 901, and parameters used during the execution, and the like.

The CPU 901, the ROM 902, and the RAM 903 are mutually connected by the host bus 904a capable of high-speed data transmission. The host bus 904a is connected to the external bus 904b such as a peripheral component interconnect/interface (PCI) bus via the bridge 904, and the external bus 904b is connected to various components via the interface 905.

The input device 906 is, for example, a device that receives an input from a user, such as a mouse, a keyboard, a touch panel, a button, a switch, or a lever. Note that, the input device 906 may be a microphone or the like that detects voice of the user. The input device 906 may be, for example, a remote control device using infrared rays or other radio waves, or may be an external connection device corresponding to an operation of the information processing device 900.

The input device 906 further includes an input control circuit that outputs an input signal generated on the basis of information input by the user to the CPU 901. The user can input various types of data or instruct a processing operation to the information processing device 900 by operating the input device 906.

The output device 907 is a device capable of visually or aurally presenting information acquired or generated by the information processing device 900 to the user. The output device 907 may be, for example, a display device such as a liquid crystal display (LCD), a plasma display panel (PDP), an organic light emitting diode (OLED) display, a hologram, or a projector, a sound output device such as a speaker or a headphone, or a printing device such as a printer device. The output device 907 can output information obtained by the processing of the information processing device 900 as a video such as a text or an image, or a sound such as voice or audio.

The storage device 908 is a data storage device configured as an example of a storage unit of the information processing device 900. The storage device 908 may include, for example, a magnetic storage device such as a hard disk drive (HDD), a semiconductor storage device, an optical storage device, a magneto-optical storage device, or the like. The storage device 908 can store programs executed by the CPU 901, various data, various data acquired from the outside, or the like.

The drive 909 is a reading or writing device of a removable recording medium such as a magnetic disk, an optical disk, a magneto-optical disk, or a semiconductor memory, and is built in or externally attached to the information processing device 900. For example, the drive 909 can read information recorded in the attached removable recording medium and output the information to the RAM 903. Furthermore, the drive 909 can write a record in the attached removable recording medium.

The connection port 910 is a port for directly connecting the external connection device to the information processing device 900. The connection port 910 may be, for example, a universal serial bus (USB) port, an IEEE 1394 port, a small computer system interface (SCSI) port, or the like. Furthermore, the connection port 910 may be an RS-232C port, an optical audio terminal, or a high-definition multimedia interface (HDMI (registered trademark)) port, or the like. The connection port 910 is connected with the external connection device, so that various data can be transmitted and received between the information processing device 900 and the external connection device.

The communication device 911 is, for example, a communication interface including a communication device or the like for connecting to the communication network 920. The communication device 911 may be, for example, a communication card for wired or wireless local area network (LAN), Wi-Fi (registered trademark), Bluetooth (registered trademark), or wireless USB (WUSB). Furthermore, the communication device 911 may be a router for optical communication, a router for asymmetric digital subscriber line (ADSL), a modem for various kinds of communication, or the like.

For example, the communication device 911 can transmit and receive signals and the like to and from the Internet or another communication device by using a predetermined protocol such as TCP/IP Furthermore, the communication network 920 connected to the communication device 911 is a network connected by wire or wirelessly, and may be, for example, an Internet communication network, a home LAN, an infrared communication network, a radio wave communication network, a satellite communication network, or the like.

Note that it is also possible to create a program for causing hardware such as a CPU 901, a ROM 902, and a RAM 903 built in a computer to exhibit functions equivalent to those of the above-described information processing device 900. Furthermore, a computer-readable recording medium in which the program is recorded can also be provided.

The preferred embodiments of the present disclosure have been described above in detail with reference to the accompanying drawings, but the technical scope of the present disclosure is not limited to such examples. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to the effects described above or instead of the effects described above.

Note that the following configurations also fall within the technological scope of the present disclosure.

(1)

An information processing device including:
a mapping unit that maps an environment image obtained by capturing an image of a surrounding environment in real time on each surface of a predetermined three-dimensional body; and
a reflection drawing unit that derives a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.
   (2)

The information processing device according to (1), in which the partial region is a region in which a reflection vector derived on the basis of a line-of-sight vector indicating a line-of-sight direction of the user and a normal vector of the surface of the virtual object intersects each surface of the predetermined three-dimensional body.

(3)

The information processing device according to (2), in which the reflection vector is derived further on the basis of a characteristic of the surface of the virtual object.

(4)

The information processing device according to any one of (1) to (3), in which the reflection drawing unit generates the reflected image further on the basis of evaluation information indicating a reflection characteristic of the surface of the virtual object.

(5)

The information processing device according to (4), in which the evaluation information is set on the basis of similarity between a texture and an image of the surface of the virtual object when the virtual object is drawn inside the predetermined three-dimensional body to which the texture is pasted.

(6)

The information processing device according to any one of (4) or (5), in which the reflection drawing unit controls at least one of resolution or a number of colors of the reflected image to be superimposed on the surface of the virtual object on the basis of the evaluation information.

(7)

The information processing device according to any one of (4) to (6), in which the reflection drawing unit determines whether or not to generate the reflected image on the basis of the evaluation information.

(8)

The information processing device according to any one of (1) to (7), in which a line-of-sight direction of the user is determined from a captured image including the user.

(9)

The information processing device according to any one of (1) to (7), in which a line-of-sight direction of the user is an imaging direction of a video see-through image obtained by imaging the real space in which the virtual object is drawn.

(10)

The information processing device according to any one of (1) to (9), in which the environment image is an image obtained by capturing a space including the user on an opposite side of the real space in which the virtual object is drawn.

(11)

The information processing device according to any one of (1) to (9), in which the environment image is generated on the basis of an image of a mirror-finished object in which the surrounding environment is reflected on a surface.

(12)

The information processing device according to (11), in which the virtual object is arranged at a relative position with respect to the mirror-finished object.

(13)

The information processing device according to any one of (1) to (12), in which resolution of the environment image is controlled on the basis of a distance between the user and the virtual object.

(14)

The information processing device according to any one of (1) to (13), in which resolution of the environment image is controlled in each region on the basis of a priority order of objects included in the each region of the environment image.

(15)

The information processing device according to any one of (1) to (14), in which the virtual object is arranged at a relative position with reference to a sensor device that captures a captured image of the real space on which the virtual object is drawn and the environment image of a space including the user on an opposite side of the real space.

(16)

The information processing device according to any one of (1) to (15), in which the reflection drawing unit derives in advance each point on a surface of the predetermined three-dimensional body corresponding to each of the surfaces of the virtual object, and generates the reflected image on the basis of the environment image mapped to the each point.

(17)

The information processing device according to any one of (1) to (16), in which the predetermined three-dimensional body is a cube.

(18)

An information processing method by an arithmetic processing device, including:
mapping an environment image obtained by capturing an image of a surrounding environment in real time on each surface of a predetermined three-dimensional body; and
deriving a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generating a reflected image to be superimposed on the surface of the virtual object by using the derived environment image of the partial region.
   (19)

A program causing a computer to function as:
a mapping unit that maps an environment image obtained by capturing an image of a surrounding environment in real time on each surface of a predetermined three-dimensional body; and
a reflection drawing unit that derives a partial region of each of surfaces of the predetermined three-dimensional body to be referred to when a virtual object is drawn inside the predetermined three-dimensional body on the basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.

### REFERENCE SIGNS LIST

10, 200, 300, 400, 500, 600 Information processing device
11, 207, 307, 407, 507, 607 Drawing unit
12, 205, 305, 405, 505, 605 Offset storage unit
13 Evaluation unit
201, 301, 501, 601 Sensor unit
202, 302, 402, 502, 602 Display unit
203, 403 Self-position estimation unit
204, 304, 404, 504, 604 Map storage unit
206, 306, 406, 506, 606 Control unit
401a First sensor unit
401b Second sensor unit
408 Internal sensor unit
503, 603 Tracking unit
608 Communication unit
609 Decoding unit
610 Environment image reflection unit
700 Sensor device
701 Sensor unit
702 Encoding unit
703 Communication unit
704 Tracking unit
705 Transmission image determination unit
706 Map storage unit
Us User
Ob Virtual object
Mr Mirror-finished body

1. An information processing device comprising:
a mapping unit that maps an environment image obtained by capturing an image of a surrounding environment in real time on each surface of a predetermined three-dimensional body; and
a reflection drawing unit that derives a partial region of each of surfaces of the predetermined three-dimensional body to be referred to when a virtual object is drawn inside the predetermined three-dimensional body on a basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.

2. The information processing device according to claim 1, wherein the partial region is a region in which a reflection vector derived on a basis of a line-of-sight vector indicating a line-of-sight direction of the user and a normal vector of the surface of the virtual object intersects each surface of the predetermined three-dimensional body.

3. The information processing device according to claim 2, wherein the reflection vector is derived further on a basis of a characteristic of the surface of the virtual object.

4. The information processing device according to claim 1, wherein the reflection drawing unit generates the reflected image further on a basis of evaluation information indicating a reflection characteristic of the surface of the virtual object.

5. The information processing device according to claim 4, wherein the evaluation information is set on a basis of similarity between a texture and an image of the surface of the virtual object when the virtual object is drawn inside the predetermined three-dimensional body to which the texture is pasted.

6. The information processing device according to claim 4, wherein the reflection drawing unit controls at least one of resolution or a number of colors of the reflected image to be superimposed on the surface of the virtual object on a basis of the evaluation information.

7. The information processing device according to claim 4, wherein the reflection drawing unit determines whether or not to generate the reflected image on a basis of the evaluation information.

8. The information processing device according to claim 1, wherein a line-of-sight direction of the user is determined from a captured image including the user.

9. The information processing device according to claim 1, wherein a line-of-sight direction of the user is an imaging direction of a video see-through image obtained by imaging the real space in which the virtual object is drawn.

10. The information processing device according to claim 1, wherein the environment image is an image obtained by capturing a space including the user on an opposite side of the real space in which the virtual object is drawn.

11. The information processing device according to claim 1, wherein the environment image is generated on a basis of an image of a mirror-finished object in which the surrounding environment is reflected on a surface.

12. The information processing device according to claim 11, wherein the virtual object is arranged at a relative position with respect to the mirror-finished object.

13. The information processing device according to claim 1, wherein resolution of the environment image is controlled on a basis of a distance between the user and the virtual object.

14. The information processing device according to claim 1, wherein resolution of the environment image is controlled in each region on a basis of a priority order of objects included in the each region of the environment image.

15. The information processing device according to claim 1, wherein the virtual object is arranged at a relative position with reference to a sensor device that captures a captured image of the real space on which the virtual object is drawn and the environment image of a space including the user on an opposite side of the real space.

16. The information processing device according to claim 1, wherein the reflection drawing unit derives in advance each point on a surface of the predetermined three-dimensional body corresponding to each of the surfaces of the virtual object, and generates the reflected image on a basis of the environment image mapped to the each point.

17. The information processing device according to claim 1, wherein the predetermined three-dimensional body is a cube.

18. An information processing method by an arithmetic processing device, comprising:
mapping an environment image obtained by capturing an image of a surrounding environment in real time on each surface of a predetermined three-dimensional body; and
deriving a partial region of each of surfaces of the predetermined three-dimensional body to be referred to when a virtual object is drawn inside the predetermined three-dimensional body on a basis of a characteristic of a surface of the virtual object to be drawn superimposed on a real space and a line-of-sight direction of a user visually recognizing the virtual object, and generating a reflected image to be superimposed on the surface of the virtual object by using the derived environment image of the partial region.

19. A program causing a computer to function as:
a mapping unit that maps an environment image obtained by capturing an image of a surrounding environment in real time on each surface of a predetermined three-dimensional body; and
a reflection drawing unit that derives a partial region of each of surfaces of the predetermined three-dimensional body to be referred to when a virtual object is drawn inside the predetermined three-dimensional body on a basis of a characteristic of a surface of the virtual object to be drawn superimposed on a real space and a line-of-sight direction of a user visually recognizing the virtual object, and generates a reflected image to be superimposed on the surface of the virtual object by using the derived environment image of the partial region.
